(19) United States
(12) Patent Application Publication
(10) Pub. No.: US 2006/0226088 A1
(43) Pub. Date: Oct. 12, 2006

(54) Disposable set for separations of blood into its components

(75) Inventors: Thomas Charles Robinson, San Francisco, CA (US); Thomas P. Sahines, Milpitas, CA (US); Richard R. D'Elia, San Mateo, CA (US); Salvador M. Zamora, Pleasanton, CA (US); Brian D. Lewis, Los Gatos, CA (US); Robert K. Fernandez, Campbell, CA (US); Victor A. Briones, Gilroy, CA (US); David M. Nier, San Jose, CA (US); Thomas Noland McNamara, Los Gatos, CA (US)

Correspondence Address: PILLSBURY WINTHROP SHAW PITTMAN LLP, P.O BOX 10500, McLean, VA, 22102, US

(73) Assignee: MISSION MEDICAL, INC., Freemont, CA (US)

(21) Appl. No.: 11/386,441

(22) Filed: Mar. 22, 2006

Related U.S. Application Data
(63) Continuation of application No. 11/102,215, filed on Apr. 8, 2005.

(51) Int. Cl. C02F 1/38

(52) U.S. Cl. 210/787; 210/512.1; 604/408; 604/410; 494/45

(57) ABSTRACT

Described herein is a continuous-flow centrifuge (CFC) which may be embodied in an automated system for collecting and separating whole blood into its components. The collection and separation system includes a console and a disposable set. Various blood processing procedures which produce specific blood products may be implemented by using a specific disposable set for each process. The disposable set may include a manifold, a CFC, and various components attached by tubing. These components may include one or more solution bags, blood product bags, bacterial filters, leukofilters, and a donor blood collection tube with access needle. The manifold and CFC disk may be included in a cassette that mounts onto the front panel of the console. The console may contain valve actuators, pressure transducers, ultrasonic sensors, a roller pump assembly, a CFC drive system, optical sensors, electronics, software, user interface components, a bar code reader and data acquisition components.

### RELATED APPLICATIONS

This application is a continuation of U.S. patent application Ser. No. 11/102,215, filed on Apr. 8, 2005, which is incorporated herein by reference.

### BACKGROUND OF THE INVENTION

1. Field of the Invention

The present invention generally relates to blood processing systems for the automated collection of blood and separation of blood into its component parts. More particularly, the present invention relates to a centrifuge which can separate blood into two or more components and may be used in such blood processing systems.

2. Description of Related Art

The adult human body contains approximately 10 units (or approximately 5,000 mL) of whole blood consisting of both cellular and liquid portions. The cellular portion (about 45% by volume) comprises red blood cells, white blood cells and platelets. The liquid portion (about 55% by volume) is made up of plasma and soluble blood proteins. Each of these components can be directly transfused into patients and used in a wide variety of therapeutic applications. Blood component therapy is used in the treatment of blood disorders and conditions involving blood loss. Platelet therapy is also used to treat side effects of chemotherapy.

The world's current whole blood supply is estimated at 75 million units annually, with approximately 45 million whole blood units per year collected from donors at either mobile or fixed collection sites in North America, Europe, Japan and Australia. In the United States, collections have declined slightly during the 1990s to 13.1 million units in 2000, or 29% of the industrialized world's collections. Western Europe accounts for 44% of collections, Japan for 16%, and 11% are collected throughout the rest of the industrialized world. Seventy five percent of donated blood is collected in the United States in mobile settings (e.g., schools, offices, and community centers), with the remaining 25% collected at fixed blood center sites.

Collection of blood is currently done through two processes: the collection of whole blood using a 50 year-old manual process and the collection of blood components through apheresis. The manual process takes about 75 to 90 minutes per unit. The process begins with the manual whole blood collection from the donor, which takes about 6 to 15 minutes. Then the unit of whole blood and the test samples are transported to a fixed blood components laboratory where the whole blood is tested, centrifuged, expressed, labeled, leukoreduced, and placed into inventory. Further centrifugation and handling are required to produce platelets. In general, manual methods of collection and separation of blood are less efficient than automated methods such as apheresis. For example, with the manual method of platelet collection, four to six collections are required to produce a therapeutic dose.

In the United States, collection of certain components is frequently performed using apheresis. This automated process collects the donor blood, removes a desired component and returns the remainder to the donor. For example, plasmapheresis (plasma) and plateletpheresis (platelets) are automated apheresis procedures developed for the collection of specific components. Plasmapheresis is the automated removal of plasma from the body through the withdrawal of blood, its separation into plasma and red blood cells, and the reinfusion of the blood cells back into the body. Plateletpheresis is the automated removal of platelets from the body through the withdrawal of blood, its separation into red blood cells, plasma, and platelets, and the re-infusion of the red blood cells and plasma back into the body.

Blood supply is low. The blood shortage is so severe that in 2000, 7% of all elective surgies in the United States were delayed due to blood shortages and the American Red Cross (ARC) has reported blood inventories of less than one day of supply. Recently, the ARC and other blood organizations around the world imposed new restrictions on donor eligibility due to “Mad Cow” disease. This and other stringent donor screening programs is predicted to reduce the pool of available donors by 8%. Nonetheless, the adoption of these programs, along with the increasing prevalence of aggressive medical procedures requiring blood components, has resulted in widespread shortages of blood products.

Additionally, there is a shrinking donor base. Less than 3% of healthy North Americans regularly donate blood. The amount of eligible donors in the United States is expected to decline by approximately 8% from its level in 2002. The decline is anticipated for a variety of reasons, including more stringent donor screening to prevent contamination of the blood supply by various diseases such as Human Immunodeficiency Virus (HIV). The regulatory climate and issues affecting the donor population would also appear to favor an alternative approach to the current blood collection procedures including the standard manual collection and separation process.

Some entities have proposed the collection of two red cell units, an apheresis procedure, during one donor session as a partial solution to supply problems. One study has suggested that the adoption of double red cell collection could reduce the required donor pool by 6% and continue to meet existing blood supply requirements from a smaller donor pool. However, many blood banks currently do not have the capacity or apheresis equipment required to perform double red cell collection.

Furthermore, most of the blood banks in the United States currently operate at or close to breakeven position. Medicare and private insurers have limited reimbursements to hospitals for the purchase of blood units. Blood centers in the United States continue to experience the usual effects that have accompanied the growth of managed health care systems. At many blood centers, the fully loaded cost to collect and process one unit of red blood cells exceeds its selling price since hospitals have enforced price pressures on blood centers. Therefore, blood centers have focused their efforts on reducing expenses to achieve breakeven.

Blood products are biological products, and blood centers must therefore operate under the United States Food and Drug Administration's (FDA) regulations and established practices. Operating in compliance with regulations and practices when utilizing manual collection and processing procedures imposes an enormous quality assurance burden, under which more than one-half of blood centers in the United States still fail to operate. Additionally, blood bank organizations have experienced significant price erosion for their blood products and have had to absorb costly, unfunded new safety and quality control procedures and tests mandated by the FDA.

Moreover, new regulations are being implemented worldwide. For example, leukocytes have been identified to cause negative physiological reactions in a small percentage of blood transfusion recipients. As a result, the FDA's Blood Products Advisory Committee has formally recommended that the FDA mandate leukocyte reduction, and nations around the world, including Canada and the United Kingdom, have adopted leukocyte filtering. Leukocytes are currently removed from red cells and platelets by manual filtration processes which are time consuming and labor intensive.

Although manual processes for blood collection and separation have some serious disadvantages, they are generally far less expensive than the automated alternatives, such as apheresis, as they do not require specialized staff, expensive equipment and disposables. Additionally, the cumbersome (large and heavy) apheresis equipment does not lend itself to transportation to or use at mobile collection sites, where the majority of blood donations are collected. In part for the foregoing reasons, although apheresis is used extensively for certain procedures, such as platelet collection where up to sixty-five percent of platelets collected in the United States are collected using plateletpheresis, apheresis has not achieved high penetration or displaced the current manual processes for blood collection and separation where one or more red cell products are obtained. Similarly, double unit collection has not been implemented, in part, because current procedures for double unit collection are expensive and relatively complex. Finally, for some procedures, such as leukocyte filtering, there are few, if any, alternatives to a time consuming and expensive manual process.

### BRIEF SUMMARY OF THE INVENTION

The present invention relates to a blood collection and processing system that reduces direct collection and processing costs, automates and standardizes collection and processing procedures, automates data collection to minimize errors, performs multiple processes (including the collection of both single and double units of red blood cells), functions well in uses at remote sites on mobile blood drives as well as at fixed, blood center sites, and simultaneously collects, processes, and leukofilters blood. The present invention further relates to a centrifuge that can be incorporated into the aforementioned blood collection and processing system.

In one embodiment, the present invention relates to an automated blood collection and separation system that includes a console and a disposable set. The disposable set may include a manifold, a continuous-flow centrifuge (CFC) (including a CFC drive cup and a CFC disk that resides therein during system operation), and various components attached by tubing (e.g., solution bags, blood product bags, bacterial filters, leukofilters, donor blood collection tube with access needle). A manifold and CFC disk may be included in a cassette that mounts onto the front panel of the console. Alternatively, the manifold and CFC disk may be mounted into the console separately (i.e., without use of a cassette). The system may contain roller pump mechanisms and a CFC drive system to drive fluids through the system; a series of valves to control the flow of fluids through the system; and pressure sensors, ultrasonic sensors and optical sensors to monitor the flow of these fluids. System electronics, software, user interface components, a bar code reader and data acquisition components may also be included to control the system's operation and instruct the performance of various tasks.

The CFC disk may include an annular separation channel positioned at or near its periphery and/or a plasma shelf that lies within the annular separation channel. The CFC disk may further include a red cell outlet port located at or near the largest radius of the separation channel. Holes and/or locking ports for angular orientation of the CFC disk may also be included, as may various fluid lines from the CFC disk to the manifold. A variety of passages and tubes may additionally be included in the CFC disk to transport fluids and various blood products. Fluids and blood products may be transported into and out of the CFC disk by way of a seal assembly that includes a series of circumferential channels; one for each fluid or blood product (e.g., whole blood, red blood cells, plasma, storage solution).

In another aspect, the present invention is directed toward a variety of processes that implement blood processing and collection procedures, employing the CFC and the inventive blood collection and processing system. By way of example, in one embodiment, one unit of leukoreduced RBCs in storage solution and one unit of plasma are produced. In another embodiment, sufficient whole blood is collected from a donor to produce two units of leukoreduced RBCs in storage solution. In a further embodiment, sufficient whole blood is collected to produce one unit of leukoreduced RBCs in storage solution and two units of plasma. In another embodiment, sufficent whole blood from a donor is processed to collect a desired volume of plasma only. In another embodiment, whole blood is collected to produce one unit of leukoreduced RBCs in storage solution, plasma and buffy coat.

Other features and advantages of the invention will become apparent from the following detailed description, taken in conjunction with the accompanying drawings, which illustrate, by way of example, various features of embodiments of the invention.

### BRIEF DESCRIPTION OF THE DRAWINGS

FIG. 1 depicts the simultaneous process steps that occur during the continuous-flow process in accordance with an embodiment of the present invention.

FIG. 2 is a schematic view of whole blood separation into leukoreduced red blood cells and plasma products in accordance with an embodiment of the present invention.

FIG. 3 is a perspective view of the disposable set in accordance with an embodiment of the present invention.

FIG. 4 is a perspective view of the console with the console's door shown open with the disposable set illustrated in FIG. 3 mounted into the console in accordance with an embodiment of the present invention.

FIG. 5 is a perspective view of the front side of the manifold illustrated in FIG. 4 in accordance with an embodiment of the present invention.

FIG. 6 a is a perspective view of the back side of the manifold assembly illustrated in FIG. 4 in accordance with an embodiment of the present invention.

FIG. 7 is an exploded perspective view of the manifold assembly depicted in FIG. 6 in accordance with an embodiment of the present invention.

FIG. 8 depicts the fluid lines of the manifold and centrifuge disk illustrated in FIG. 4 in accordance with an embodiment of the present invention.

FIG. 9 is a horizontal cross-sectional view of the door-manifold-transducer plate interactions with the solenoid energized and valve open in accordance with an embodiment of the present invention.

FIG. 10 is a horizontal cross-sectional view of the door-manifold-transducer plate interactions and pressure sensing components in accordance with an embodiment of the present invention.

FIG. 11 is a horizontal cross-sectional view of the negative pressure sensing components with vacuum coupling in accordance with an embodiment of the present invention.

FIG. 12 is a horizontal cross-sectional view of the ultrasonic sensor and tubing showing the finger engagement by door closure in accordance with an embodiment of the present invention.

FIG. 13 is a perspective view of the donor access sub-assembly depicted in FIG. 3 in accordance with an embodiment of the present invention.

FIG. 14 is a horizontal cross-sectional view of the manifold in accordance with an embodiment of the present invention.

FIG. 15 is a longitudinal cross-sectional view schematic of the centrifuge disk separation channel in accordance with an embodiment of the present invention.

FIG. 16 is a top view schematic of the centrifuge disk separation channel in accordance with an embodiment of the present invention.

FIG. 17 is an axial isometric view of the centrifuge disk in accordance with an embodiment of the present invention.

FIG. 18 is a longitudinal cross-sectional view through red blood cell and whole blood ports of the centrifuge disk in accordance with an embodiment of the present invention.

FIG. 19 is a back view of the centrifuge disk in accordance with an embodiment of the present invention.

FIG. 20 is a center horizontal isometric sectional view of the centrifuge disk in accordance with an embodiment of the present invention.

FIG. 21 is a longitudinal cross-sectional view of the continuous-flow centrifuge disk face seal and its fluid paths depicted in FIG. 20 in accordance with an embodiment of the present invention.

FIG. 22 is a horizontal cross-sectional view of the centrifuge disk seal assembly depicted in FIG. 21 in accordance with an embodiment of the present invention.

FIG. 23 is a perspective view of the front side of the console with the display deployed in accordance with an embodiment of the present invention.

FIGS. 24-26 are perspective views of the console deployment process in accordance with an embodiment of the present invention. FIG. 24 is a perspective view of the console in the closed position. FIG. 25 is a perspective view of the console with the user interface deployed as depicted in FIG. 23. FIG. 26 is a perspective view of the console with the door open.

FIG. 27 is a perspective view of the console front panel in accordance with an embodiment of the present invention.

FIG. 28 is a longitudinal cross-sectional view of the continuous-flow centrifuge disk mounted in the console in accordance with an embodiment of the present invention.

FIG. 29 is a vertical cross-sectional view of the roller pump and tubing engagement in accordance with an embodiment of the present invention.

FIG. 30 is a longitudinal cross-sectional view of the continuous-flow centrifuge disk and red blood cell interface optical detector pathway in accordance with an embodiment of the present invention.

FIG. 31 is a longitudinal cross-sectional view of the continuous-flow centrifuge disk and plasma interface optical detector pathway in accordance with an embodiment of the present invention.

FIGS. 32A-E depict the two-way rotary tubing pinch valve mechanism in accordance with an embodiment of the present invention.

FIGS. 33A-F depict the four-way rotary tubing pinch valve mechanism in accordance with an embodiment of the present invention.

FIG. 34 depicts a process schematic diagram for producing two units of leukoreduced RBCs in accordance with an embodiment of the present invention.

FIG. 35 depicts a process schematic diagram for the RBCP Process in accordance with an embodiment of the present invention.

FIG. 36 depicts a process schematic diagram for the Plasma Only Process in accordance with an embodiment of the present invention.

### DETAILED DESCRIPTION OF THE INVENTION

The present invention relates to a blood collection and processing system, which includes, in one embodiment, a continuous-flow centrifuge (CFC). The CFC may, in turn, include a CFC drive cup and a CFC disk. The blood collection and processing system uses a console with electromechanical instrumentation that can perform an array of different processes to collect and/or process blood products. In connection with each of these different processes, the blood collection and processing system may use correspondingly different disposable sets that function interactively with the system's console. The disposable sets may be used to generate one or more blood products particular to a respective process. For example, blood products that result from each process may include: one or more units of leukoreduced packed red cells in storage (additive) solution; one or more units of plasma meeting the requirements of plasma fractionators and of fresh frozen plasma; and one or more units of buffy coat.

The console may include roller pump mechanisms to pump fluids through the disposable set and a CFC drive system to drive fluids to control CFC rotational speed; a series of valves to control the flow of fluids through the system; and pressure sensors, ultrasonic sensors and optical sensors to monitor the location and/or flow of these fluids. System electronics, software, user interface components, a bar code reader and/or data acquisition components may also be included to control the system's operation and instruct the performance of various tasks.

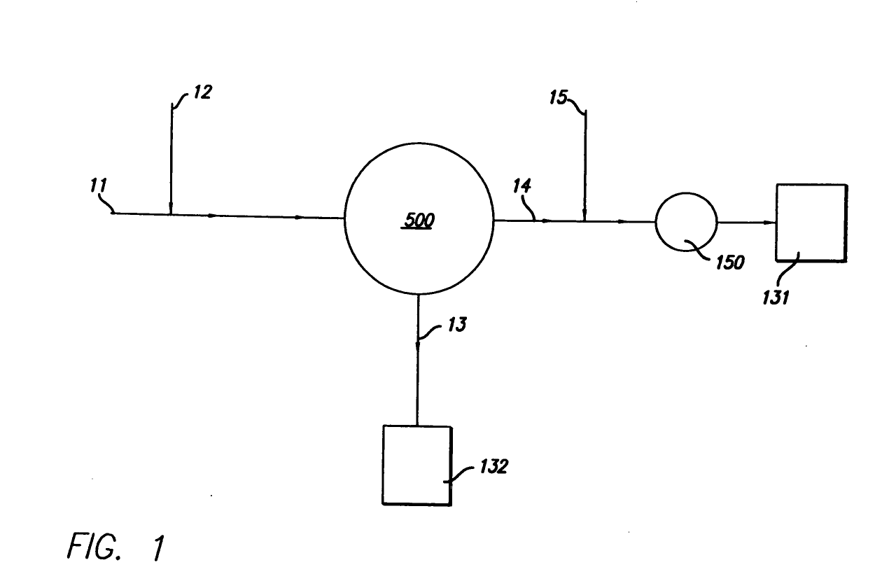

The CFC and other components of the disposable set can be used in connection with a variety of system functions, including simultaneous blood collection, anticoagulant addition, blood component separation and removal to blood product bags, red cell storage solution addition, and red cell leukofiltration. These processes may occur with continuous flow rates from the donor through the CFC disk and leukofilter to the blood component bags, as shown in FIG. 1, which depicts the simultaneous process steps that occur during the continuous flow processing of the present invention.

As shown in FIG. 1, in an embodiment of the invention, anticoagulant 12 is pumped into the donor whole blood flow 11 before the blood reaches the CFC 500. From the CFC 500, the blood is separated into red blood cells (“RBC”) and plasma which flow into separate paths. Red cell storage solution 15 is pumped into the packed red blood cell flow 14 before it enters the leukofilter 150. From the leukofilter 150, the red blood cells are collected into a red blood cell product bag 131. The plasma flow 13 from the CFC 500 enters a plasma product bag 132. In this process, the red cell and plasma products are separated from one unit of whole blood taken from a donor. This process represents a general form of automated blood collection and processing; however, as no fluids are returned to the donor, this is not considered apheresis.

As will be readily appreciated by one of skill in the art, one unit of whole blood usually has a volume of 450 mL or 500 mL in the United States. This whole blood volume does not include the anticoagulant volume added to whole blood during its collection.

Disposable Set

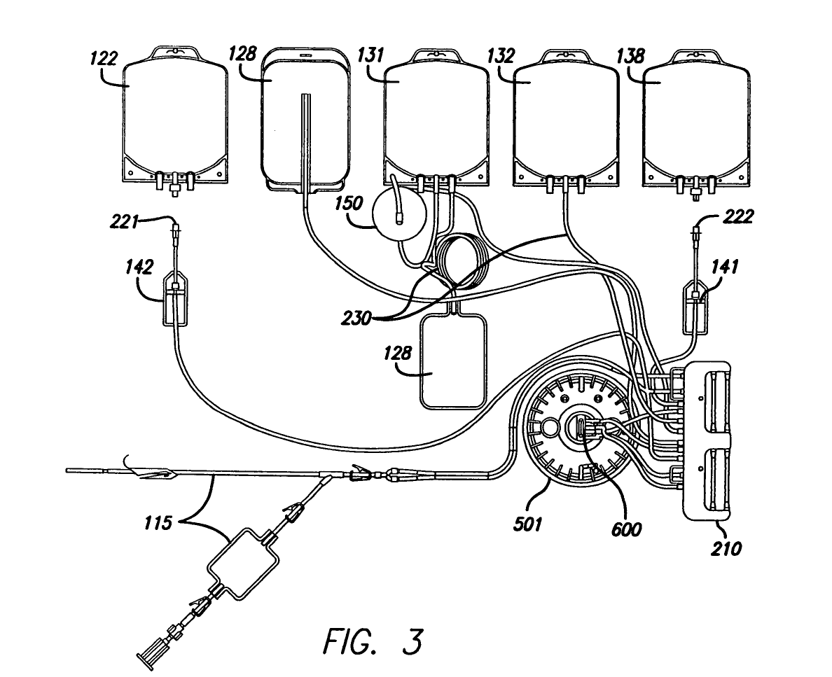

As illustratively depicted in FIG. 3, each disposable set may include a manifold 210, a CFC disk 501 with seal assembly 600 and additional components attached thereto by tubing 230. These components may include one or more solution (e.g., anticoagulant, storage solution) bags 122, 138; blood product bags (e.g., red blood cells, plasma) 131, 132; air bag 128; bacterial filters 141,142; and leukofilter 150. Luer lock connectors 221 and 222 may be used to connect the storage solution bag 122 and anticoagulant bag 138 to the tubing 230. A donor blood collection tube with access needle along with other elements of a donor access sub-assembly 115 may also be included in those embodiments of the present invention wherein blood is drawn from a donor and fluid may be returned to the donor (i.e., apheresis).

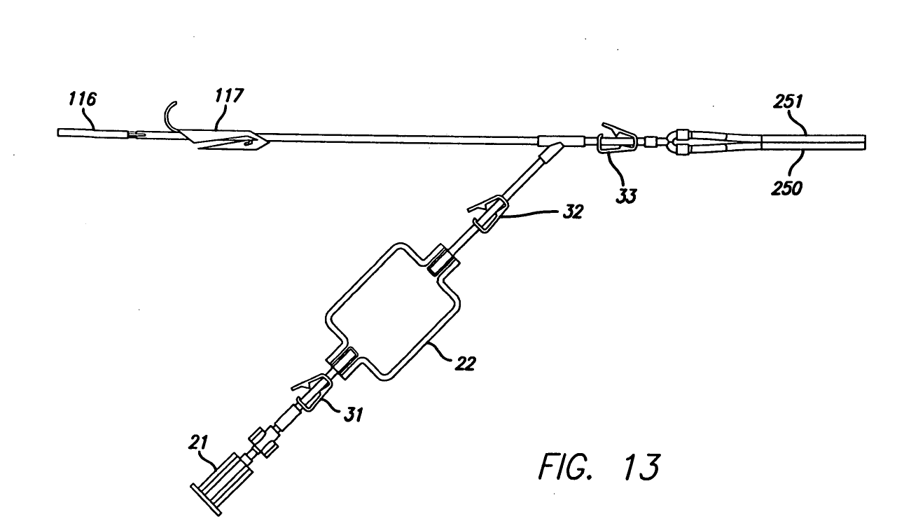

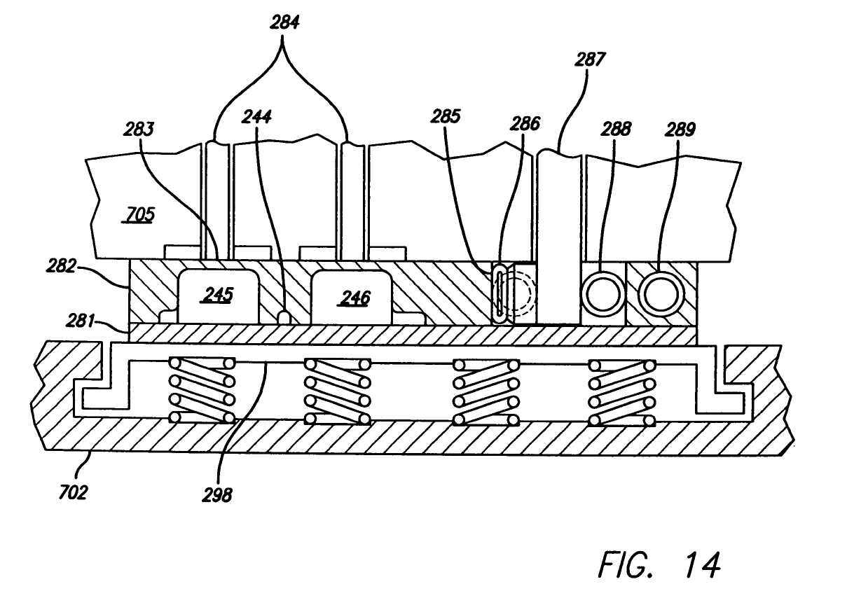

A donor access sub-assembly is illustrated in greater detail in FIG. 13. It may include a needle with cap 116; a needle safety guard 117; a sample site 21 configured for interaction with a sample tube, such as a VACUTAINER sample tube; manual clamps 31, 32 and 33; and a sample pouch or diversion bag 22. FIG. 13 also illustrates a whole blood to manifold line 250 and anticoagulant from manifold line 251. In one embodiment of the invention, an initial whole blood flow from a donor enters the sample pouch or diversion bag 22. This pouch or bag is then clamped and sealed off from the donor line and blood samples are taken. Manual clamp 33, which is configured downstream from the sample pouch 22, is then unclamped, and blood from the donor is pumped into the CFC disk, after anticoagulant addition, via the whole blood to manifold line 250.

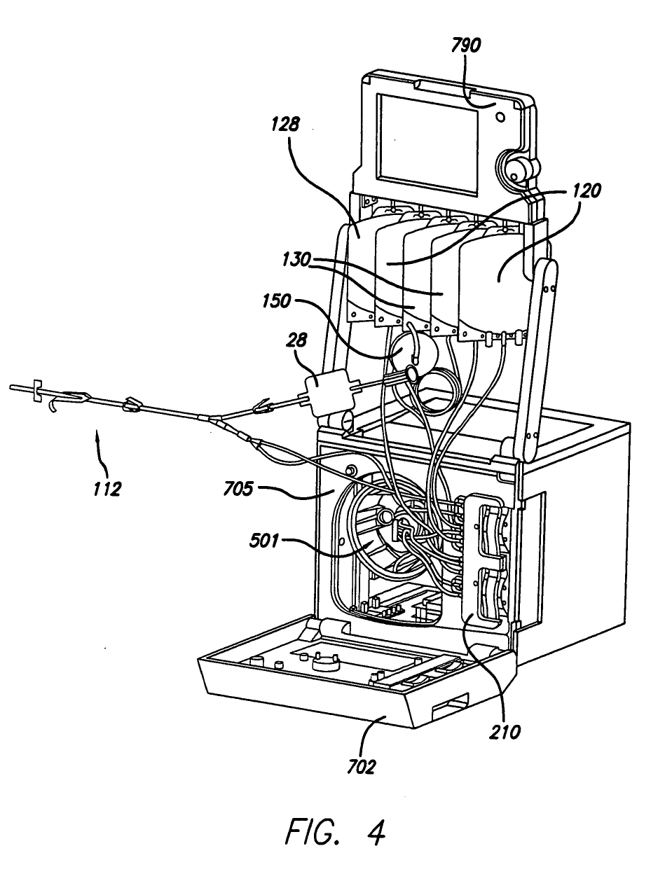

As illustrated in FIG. 4, the manifold 210 and CFC disk 501 are configured to be mounted on the front panel 705 of the console. As described above, these components remain in fluid communication with one another by virtue of tubing and a series of additional components. In one embodiment, the manifold 210 and CFC disk 501 are configured to be individually mounted on the front panel 705 of the console. In an alternate embodiment, the manifold 210 and CFC disk 501 are included on a cassette frame (not shown), and the cassette frame is configured to be removably mounted onto the front panel 705 of the console. Mounting the cassette frame onto the front panel 705 of the console correspondingly mounts the manifold 210 and CFC disk 501 thereupon. The cassette frame may be made of an injection-molded plastic with sufficient rigidity to support the manifold 210 and CFC disk 501, and to orient these components opposite the actuators and sensors mounted on the console front panel and doors when the system is assembled for use. The manifold 210 may be bonded or ultrasonically welded to the cassette frame, and a support structure for the CFC disk 501 stationary seal assembly may be attached or bonded to the cassette frame.

As illustrated in FIG. 4, once the manifold 210 and CFC disk 501 are mounted onto the front panel 705 of the console, the console door 702 may be closed to secure the manifold 210 and CFC disk 501 between the console door 702 and the console front panel 705. Vertical orientation of the manifold 210 and CFC disk 501 on a vertical console front panel 705 enables gravity to aid in separating air from liquid in disposable set components; thereby making air removal easier (air moves upward along vertical fluid pathways). Additionally, any fluid leaks tend to migrate downward along vertical surfaces for collection at the bottom of the console, in the well containing the CFC disk 501, and are thus easily visualized. This imparts a safety feature to the system, as fluid leaks may be readily detected.

The manifold 210 (or the cassette) may be secured in place on the front panel 705 of the console by pins or similar mechanical elements that engage alignment holes or similar elements in the manifold 210 (or the cassette). The console door 702 is configured to close over the manifold 210 and to thereby secure the manifold 210 against the console front panel 705. In various embodiments of the present invention, particular elements of sensing components (e.g., pressure sensors, ultrasonic sensors) are included in the manifold 210, while other elements of these components are included in the console front panel 705.

Furthermore, the system may include a series of valves that control the flow of fluids through the tubing and other components in the disposable set. In one embodiment of the invention, the valves may be configured on the front panel 705 of the console, and the tubing may be brought into mechanical communication with the valves when the manifold 210 is mounted on the front panel 705 and the console door 702 is subsequently closed. Rotary pinch valves may be appropriate for use in connection with this embodiment of the invention, although other types of valves may be used as well. Alternatively, the valves (or particular elements thereof) may be configured on the manifold 210. Remaining elements of the valves may be included upon the front panel 705 of the console and configured so as to interact with the elements on the manifold 210 when the manifold 210 is mounted to the front panel 705. Alternatively, entire valve assemblies may be configured upon the manifold 210.

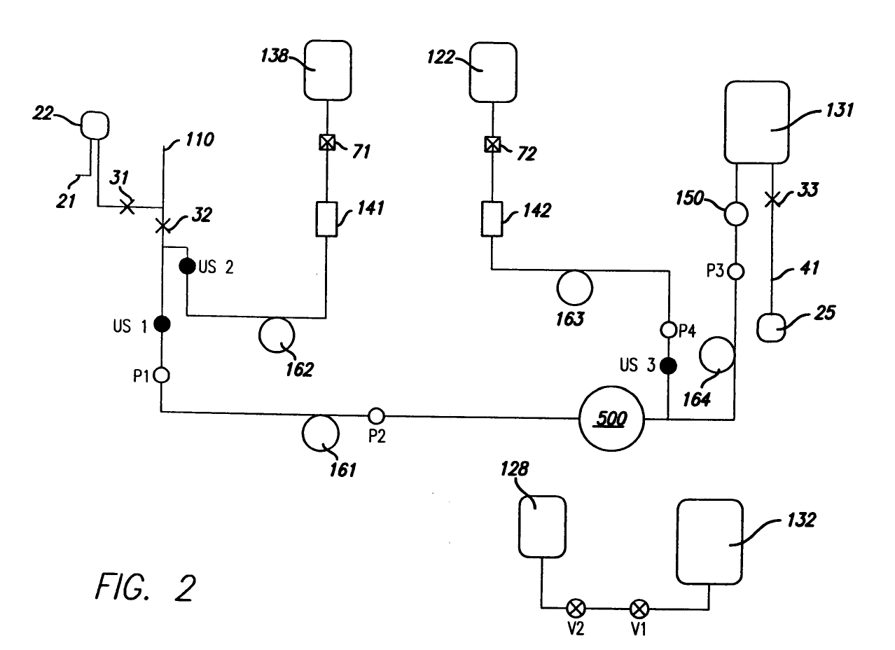

The selection of particular components, bags, and tubing and the configuration thereof in a disposable set depend upon the particular process to be implemented with the system of the invention. One configuration used in accordance with an embodiment of the invention is illustrated in FIG. 2, which depicts a schematic for a process to produce one bag of leukoreduced red blood cells in storage solution and one bag of plasma. Components used in the disposable set for each process and the configuration of those components with one another (as well as their relationship with the CFC disk and manifold) are selected accordingly.

Manifold

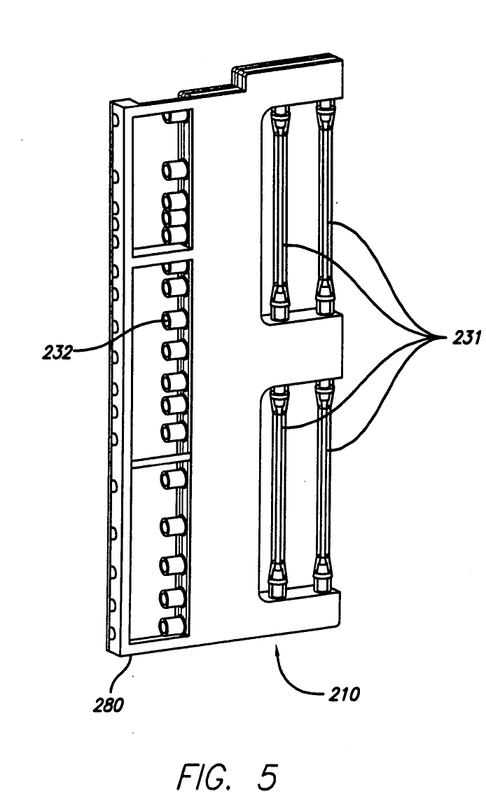

As illustrated in FIGS. 5-7, the manifold 210 may include a series of components to control and monitor the flow of fluids through the system. Various fluids travel through the manifold's interior via a series of fluid flow pathways 240. These pathways 240 may be molded directly into the manifold 210 to establish fluid communication among the various components thereof (e.g., sensing and actuation components, etc.). These fluids may additionally travel through tubing exterior to the manifold; thereby enabling fluid communication between the manifold and other components of the system's disposable set as well as with a donor, as described above.

The manifold 210 supports tubing attached between it and other system components. In particular, the manifold 210 may support a series of tubing segments that are configured for interaction with other system components upon mounting of the manifold 210 to the console front panel 705 and the subsequent closing of the console door 702. In one embodiment of the present invention, as illustrated in FIGS. 5-7, tubing segments may be braced in position by a frame 280 that extends outward from the manifold 210. Particular tubing segments may thus be braced in position by an attachment fitting on the manifold 210 on one end of the segment, and an aperture in the frame 280 that the tubing segment passes through at its other end.

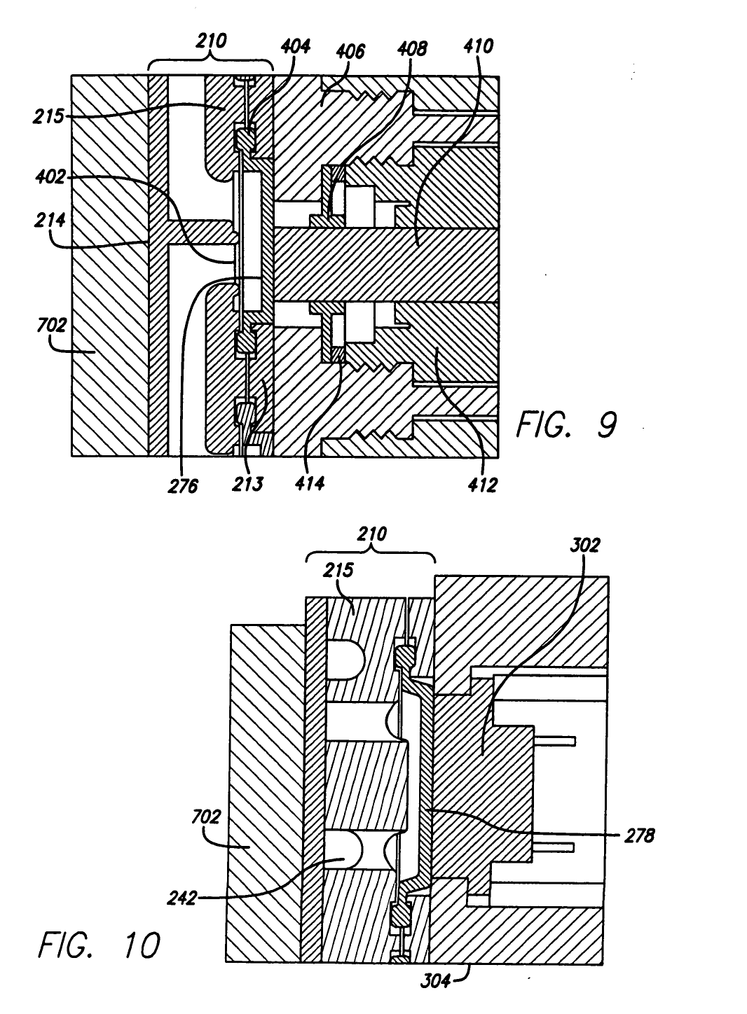

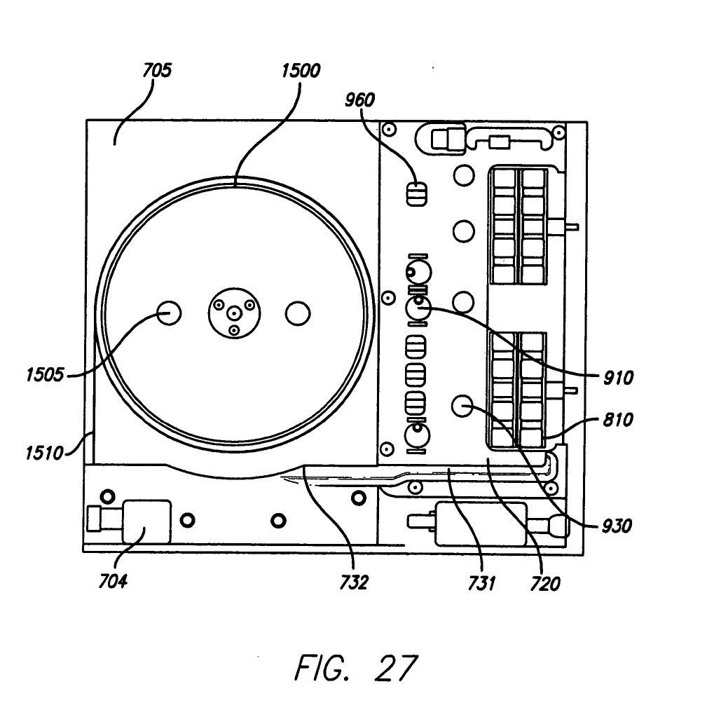

By way of example, selected tubing segments may be positioned in this manner opposite rotary valves on the console front panel 705. The rotary valves may impart sufficient pressure on the tubing segment so as to cut off the flow of fluid through the tubing segment, or, in an alternate position, the rotary valves may impart little or no pressure to the tubing segment; thereby allowing the free flow of fluid through the tubing segment. Alternatively, as seen in FIG. 9, a solenoid valve may be used, including a solenoid valve 412, solenoid seal 408, and solenoid washer 414, which may be mounted in the console front panel 705 (FIG. 27). A central armature or valve plunger 410 is spring-loaded and deforms the elastomeric valve diaphragm 276 against an opening of a flow path or valve orifice 402 in the manifold mid-body 215, occluding or blocking this opening and preventing flow in or out of the valve component. When the solenoid is actuated, the valve plunger 410 pulls away from this opening and flow can occur. The valve diaphragm 276 is located on the manifold mid-body 215 opposite the solenoid components. The valve orifice 402, which is part of a fluid pathway, has a raised annulus around it against which the valve plunger 410 pushes the diaphragm 276, creating a seal and closing the valve orifice 402 and fluid flow path. When the solenoid is energized, the valve plunger 410 pulls away from the manifold 210, allowing the valve diaphragm 276 to pull away from the valve orifice 402 due to its elastomeric bias, and the fluid path is open. The valve diaphragm 276 is normally in an open position when not deformed by the valve plunger 410, and resists deformation by the valve plunger 410 to close the solenoid valve 412. The valve diaphragm 276 also resists negative pressures and does not close when exposed to such negative pressures within the fluid path.

Additionally, segments of selected tubes may be located opposite ultrasonic sensors upon the console front panel. As illustrated in FIG. 12, a segment of tubing supported by the manifold may be configured such that a yoke-shaped ultrasonic sensor 450 may surround the tubing segment 457 on three sides. When the console door 702 is closed, one or more fingers 455 attached to the console door 702 push the tubing segment 457 into the slot in the sensor 450, and compress the tubing segment 457. This forces the tubing segment 457 into secure contact with the sides of the sensor 450, achieving good acoustic coupling. The transducer elements of the sensor may be mounted inside the material surfaces of the opposing sides of this slot. In operation, the sensor 450 sends ultrasonic waves through the tubing segment 457. The differences in acoustic properties between liquids, air, and air bubbles in liquids are determined by the sensor 450 and its electronics. This can assist in safety to prevent air from entering the donor in the event of a system malfunction, to ensure that a particular process is occurring without air bubbles in the system tubing, and to detect when liquid-containing bags become empty of liquid. In alternate embodiments of the instant invention, the volume of any or all of the bags may be determined by their weight. This may be accomplished by hanging the bags from individual scales located in the console (not shown) or located just below the display screen.

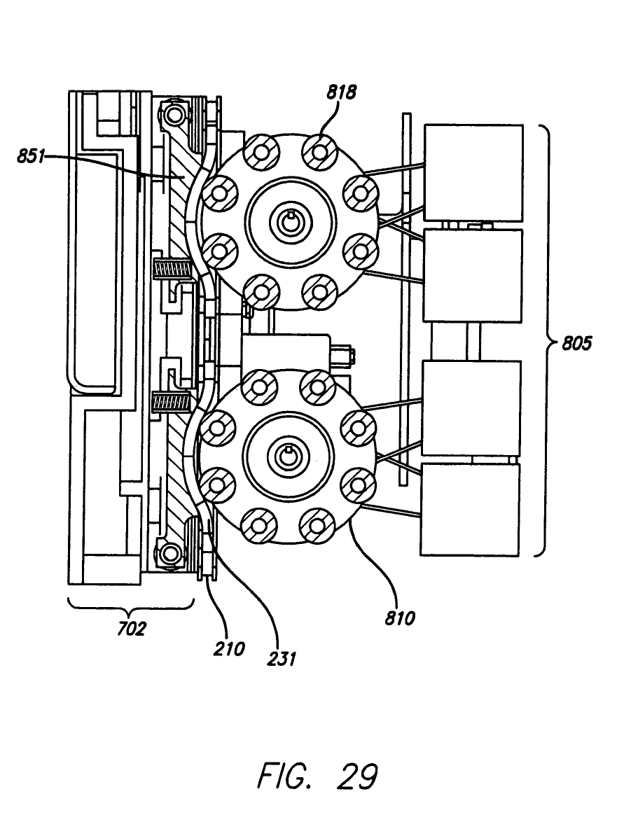

Additionally, at least one roller pump tubing section 231 (with at least one corresponding roller pump in the console front panel) may be included in the manifold 210 for fluid flow control. In the embodiment of the instant invention depicted in FIGS. 5-7, four such tubing segments 231 are included. Moreover, as illustrated in FIG. 29, the roller pump tubing segments 231 engage roller pumps 810 in the console when the console door 702 is closed, and the manifold 210 is secured between the console door 702 and the console front panel 705. Thereafter, upon rotation of the roller pumps 810, fluid may be forced through the corresponding tubing segments 231; thereby driving the fluid through the system.

As seen in FIG. 7, the manifold structure includes four parts: a back cover 214 (nearest the console front panel) that seals one or more diaphragms that operate in connection with one or more corresponding pressure transducers located in the console front panel, a mid-body 215 into which fluid flow channels are molded from one side, and a front cover 213 (nearest the console door) that covers and seals all fluid flow channels, and a clip 216 that secures tubes in the slots of frame 280. In one embodiment, illustratively depicted in FIG. 7, the back cover 214 traps elastomer diaphragms 272 (that may either be independently molded or two-shot molded to the back cover 214) between the back cover 214 and the mid-body 215. The elastomeric diaphragms 272 provide the deformable surfaces for pressure sensors. In one embodiment of the present invention (not shown), there are valve diaphragms deformed by solenoid plungers in the console to contact and occlude a tubular port molded into the mid-body 215 and thereby close a corresponding fluid pathway. In another example, the pressure diaphragms contact pressure transducer faces to expose the transducer face to the fluid pressure. The front cover 213 and back cover 214 may be ultrasonically welded to the mid-body 215 along each side of each component and channel, preventing fluid leaks between channels or to the outside. Variations in the manifold design are possible that would accommodate the various processes employed in different embodiments of the present invention and disposable set designs.

FIG. 10 illustrates the design of the positive pressure sensing components which are integrated and molded into the manifold. FIG. 10 also depicts the interactions between the console door 702, manifold 210 and pressure transducer 302. A flexible elastomeric pressure diaphragm 278 for pressure sensing is exposed to fluid and a fluid path on its inner (manifold mid-body 215 facing) surface. The outer surface of this diaphragm contacts the face of a pressure transducer 302 attached to the console front panel (FIG. 10), where the console door 702 is closed and the manifold 210 is pushed against the console front panel. A pressure transducer plate 304 is located adjacent to the manifold 210. Fluid pathways 242 bring fluid into and out of the manifold mid-body 215 adjacent to the pressure diaphragm 278. The pressure diaphragm 278 contacts the face of a pressure sensor. This sensor is mounted to the console front panel. The fluid exerts pressure across the highly flexible pressure diaphragm 278 to the sensor face, with high accuracy in measuring this pressure. The transducer output is reset to zero every time a new cassette is installed and before the process is begun, with ambient air pressure inside the manifold.

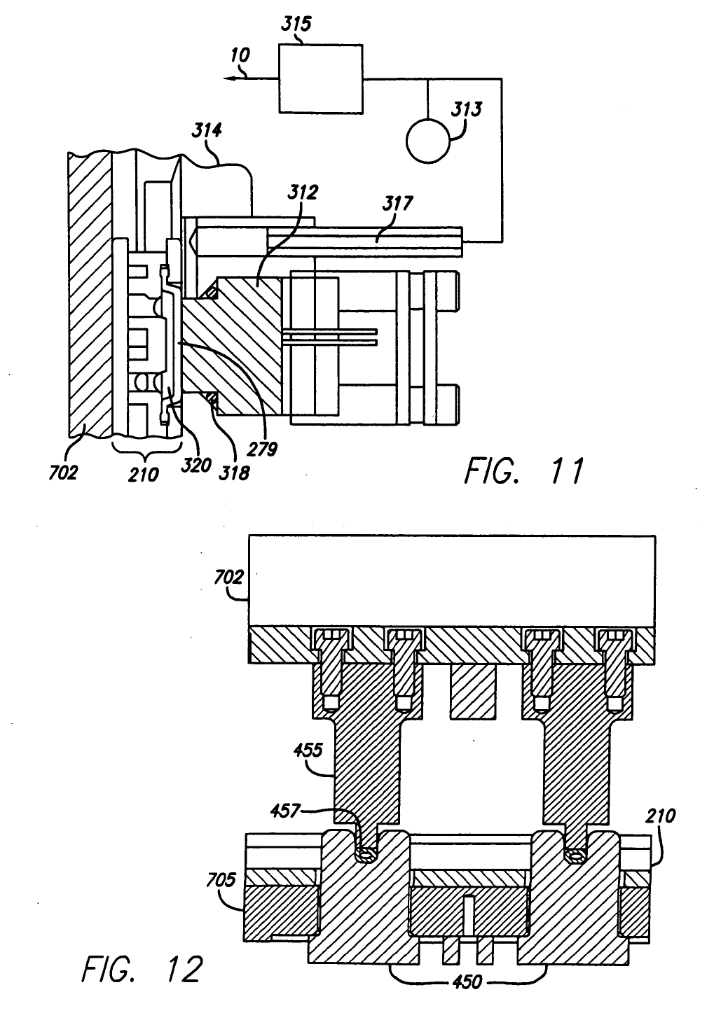

FIG. 11 depicts the design of the negative pressure sensing components which include a vacuum pump 315, vacuum line 317, pressure transducers 312 and 313, pressure transducer plate 314, O-Ring seal 318, and pressure diagram 279. FIG. 11 illustrates the console door 702 in the closed position. A vacuum is applied external to the flat sensor face but internal to a seal made at the outer edge of the elastomeric pressure diaphragm 279 and the front panel face. This vacuum level may be about −400 mm Hg. Then a negative fluid pressure can be measured down to about −350 mmHg before the pressure diaphragm 279 pulls away from the pressure sensor face located in the console front panel. The vacuum functions to keep the pressure diaphragm 279 in contact with the pressure sensor face during negative fluid pressures. This pressure sensor also measures positive pressures. Fluid pressure measurement 320 occurs at the pressure diaphragm 279 inner (manifold mid-body 215 facing) surface. A small electric motor driven vacuum pump 315 in the console provides this vacuum level. A pressure transducer 313 is used to measure the vacuum and ensure its adequacy. This measurement permits the vacuum pump to be cycled on and off to conserve power. It also detects leaks at the diaphragm-console front panel interface. From the vacuum pump 315, air is pumped into ambient air 10.

In an alternate embodiment of the invention, rigid plastic diaphragms may be used rather than elastomeric diaphragms (not shown). A rigid pressure-sensing plastic diaphragm may be integrally molded with the manifold and located opposite the console front panel. Such diaphragms may be in the range of from about 0.3 to about 1.0 inches in diameter and from about 0.020 to about 0.080 inches thick. The small deformation of the plastic diaphragm may be measured with a position sensor (e.g., a linear variable differential transformer).

The manifold fluid pumping components are depicted in FIGS. 5-8 and include pump tubing 231, connectors 234 to pump tubing 231, tubing sockets 232, and fluid flow channels 240. The four disposable pump tubing 231 components are segments that may be composed of extruded PVC or silicone tubing formulated and dimensioned to have properties optimized for roller pump use. This tubing is slightly stretched onto barbed fittings or connectors 234, which are molded to and are part of the manifold mid-body 215 (FIG. 7).

The pump tubing inside diameter may be selected for the flow rates of fluid desired, the degree of “pulsatility” of the fluid that can be allowed, and the speed range capability of the pump rotors. This inside diameter is controlled precisely in order to achieve accurate flow control. The pump rotor speeds are accurately controlled using feedback from encoders on the electrical motors that drive the pump rotors.

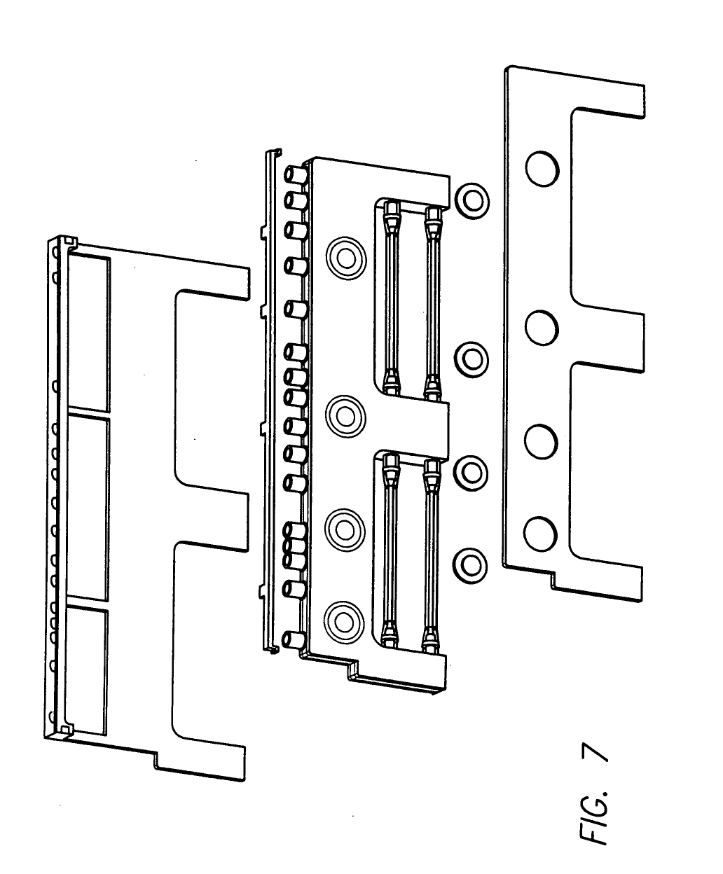

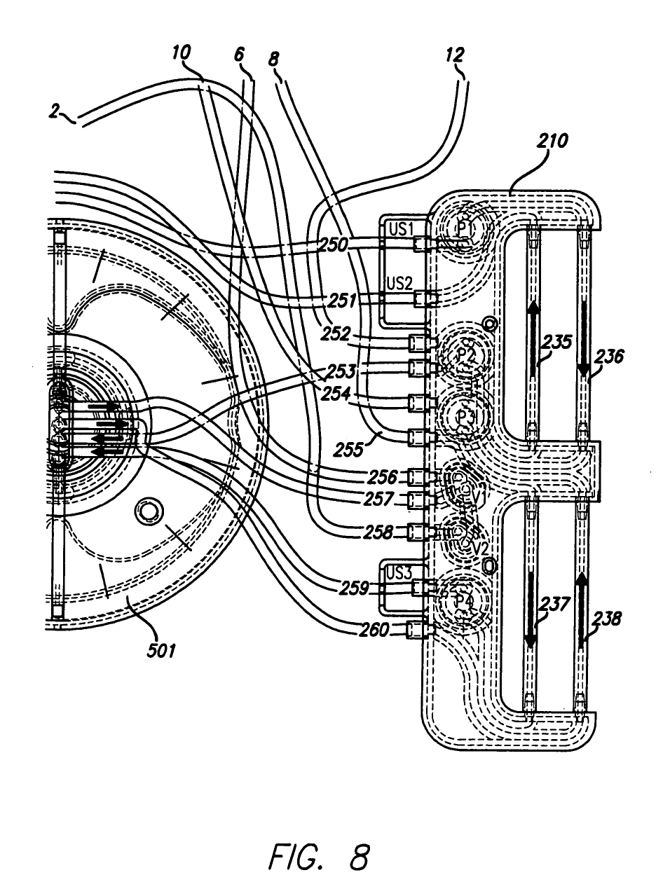

FIG. 8 depicts the fluid lines of the manifold 210 and CFC disk 501, in accordance with one embodiment of the invention. Lines containing storage solution 2, air 10, RBC 6, plasma 8, and anticoagulant 12 are depicted. FIG. 8 illustrates the following fluid lines: whole blood from donor to manifold line 250; anticoagulant from manifold line 251; anticoagulant line from anticoagulant bag to manifold line 252; whole blood from manifold to centrifuge line 253; RBC from manifold line 254; storage solution to manifold line 255; plasma from manifold line 256; plasma from CFC disk to manifold line 257; air from manifold line 258; storage solution from manifold to CFC disk line 259; and RBC from CFC disk to manifold line 260. Anticoagulant pump tubing flow 235, whole blood pump tubing flow 236, solution pump tubing flow 237, and RBC pump tubing flow 238 run vertically with respect to the manifold 210 and console. Pressure sensing components P1, P2, P3, and P4 and solenoid valve components V1 and V2 are arranged vertically to one another in the manifold 210 and communicate with the various fluid lines in the manifold 210. In alternate embodiments of the present invention, as discussed above, rotary valves may be used rather than the aforementioned solenoid valves.

It will be appreciated by those skilled in the art that a variety of manifold designs may be used with the present invention. For instance, the manifold design may be simplified by the elimination of valves, the elimination of ultrasonic sensors, and/or by the reduction of the number of tubing connections.

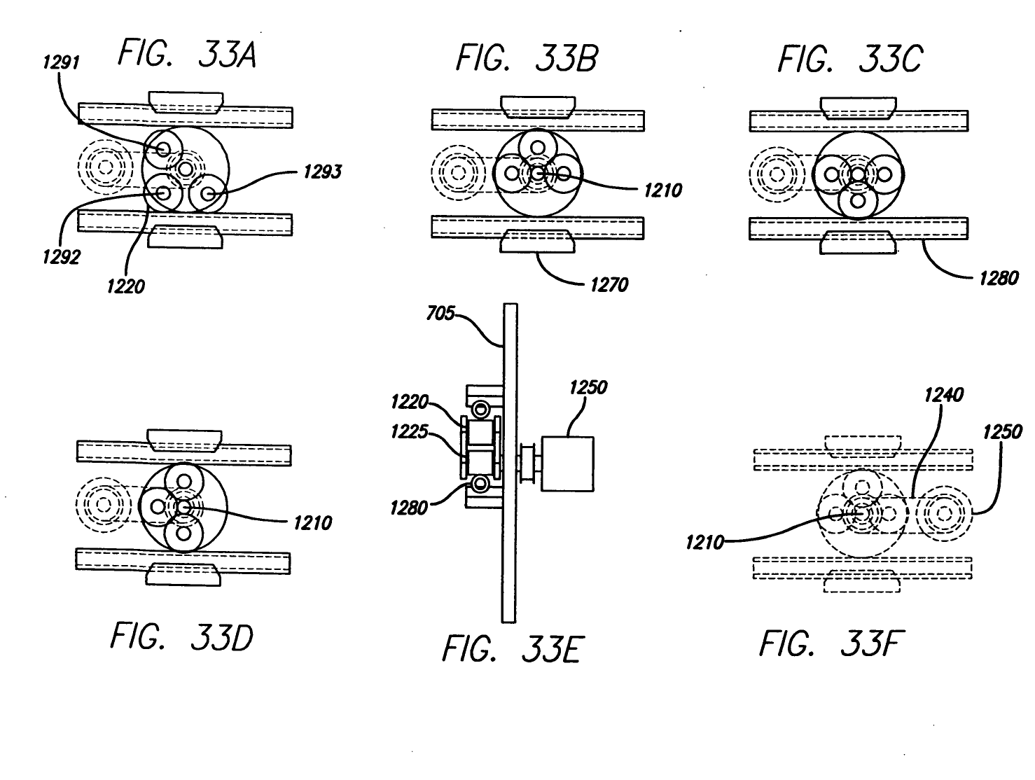

In an alternate embodiment, the valve may include a four-way rotary tubing pinch valve mechanism, as illustrated in FIGS. 33A-33F. This design permits rotating the rotor 1210 to four positions (FIG. 33A-D) and allows one mechanism to control the independent opening and closing of two tubes 1280, acting as two valves. As seen in FIG. 33A this design includes a pump rotor 1210 with three rollers 1291, 1292 and 1293 which are situated at 90° relative to each other, with one 180° gap (e.g., rollers 1291 and 1293 are situated 180 degrees relative to each other). Rollers 1291, 1292 and 1293 are located at 0°, 180°, and 270° relative to each other on the rotor 1210. The rotor 1210 engages two parallel horizontal tubes 1280 attached to the manifold, one above the rotor 1210 and one below it. As illustrated in FIG. 33B, plates or spring loaded or rigid stops 1270 in both vertical directions are located on the side of each of the tubes 1280, opposite a roller to ensure tube occlusion by the roller even with misalignment of the manifold relative to the rotor 1210 (of perhaps 0.02 to 0.03 inch in any direction in a plane parallel to the console front panel). As illustrated in FIG. 33F, an electromechanical actuator or motor 1250 (e.g., a brushless D.C. motor, such as a gear motor), is connected directly or by a drive belt 1240 to the rotor 1210 via pulleys on the motor 1250 and rotor 1210. As seen in FIG. 33E, the rotor 1210 and its drive belt 1240 may be supported by a bearing 1220 and bearing support 1225 in the console front panel 705. The rotor 1210 may be removable for cleaning.

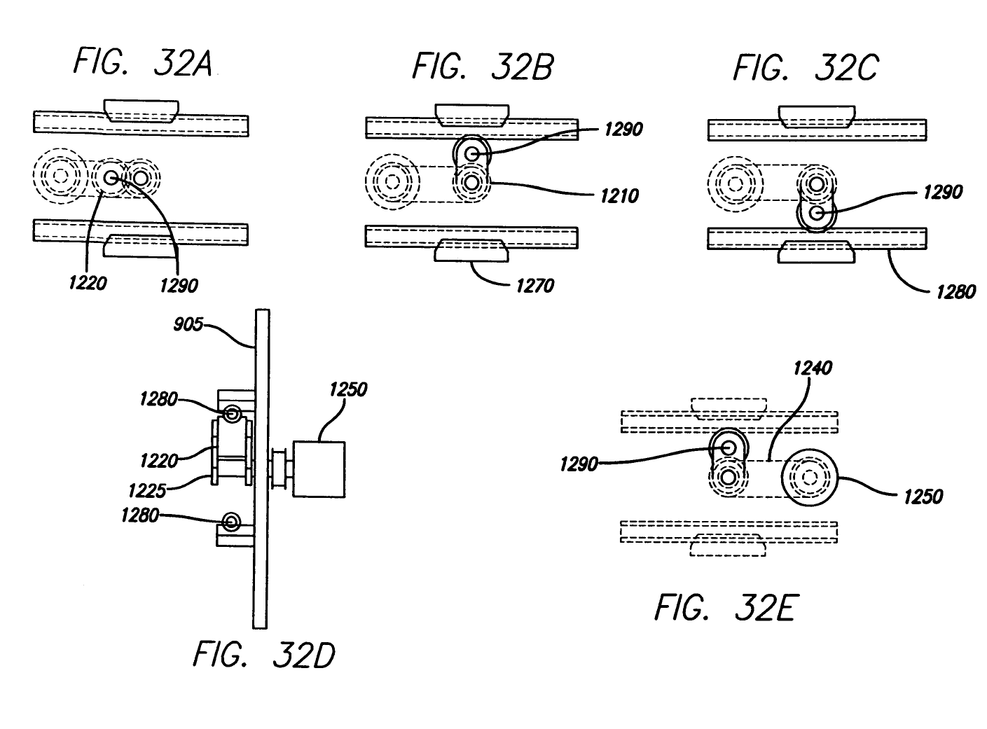

In an alternate embodiment (FIGS. 32A-E), the valve design may include a two-way rotary tubing pinch valve mechanism. This design includes a single rotor 1210 with one roller 1290. This design permits rotating the rotor 1210 to three positions: both tubes 1280 open (FIG. 32A), one tube closed (FIG. 32B), and the other tube closed (FIG. 32C). One mechanism can thus control the alternate opening and closing of two tubes 1290. In this design, one tube is open when the other tube is closed. The flow in each tube may be controlled (one at a time) by a single pump. The pump (when off) provides the condition where both tubes 290 cannot flow. Flow from one tube to the other may be prevented by occluding one tube with the roller 1290.

As seen in FIG. 32B, plates or spring-loaded or rigid stops 1270 in both vertical directions may be located on the side of each of the tubes 1280, opposite a roller, to ensure tube occlusion by the roller even with misalignment of the manifold relative to the rotor 1210 (of perhaps 0.02 to 0.03 inches in any direction in a plane parallel to the console front panel). As illustrated in FIG. 32E, an electromechanical actuator or motor 1250 (e.g., a brushless D.C. motor, such as a gear motor), may be connected directly or by a drive belt 1240 to the rotor 1210 via pulleys on the motor 1250 and rotor 1210. As seen in FIG. 32D, the rotor 1210 and its drive belt 1240 may be supported by a bearing 1220 and bearing support 1225 in the console front panel 705, and the rotor 1210 may be removable for cleaning.

Continuous-Flow Centrifuge

The CFC disk of the present invention may be used, among other things, to separate whole blood into its component parts. In this embodiment of the present invention, whole blood is pumped into the CFC disk. The blood may be anticoagulated prior to being pumped into the CFC disk, and the CFC disk may be rotating when the whole blood is introduced thereto at a sufficient speed to separate it.

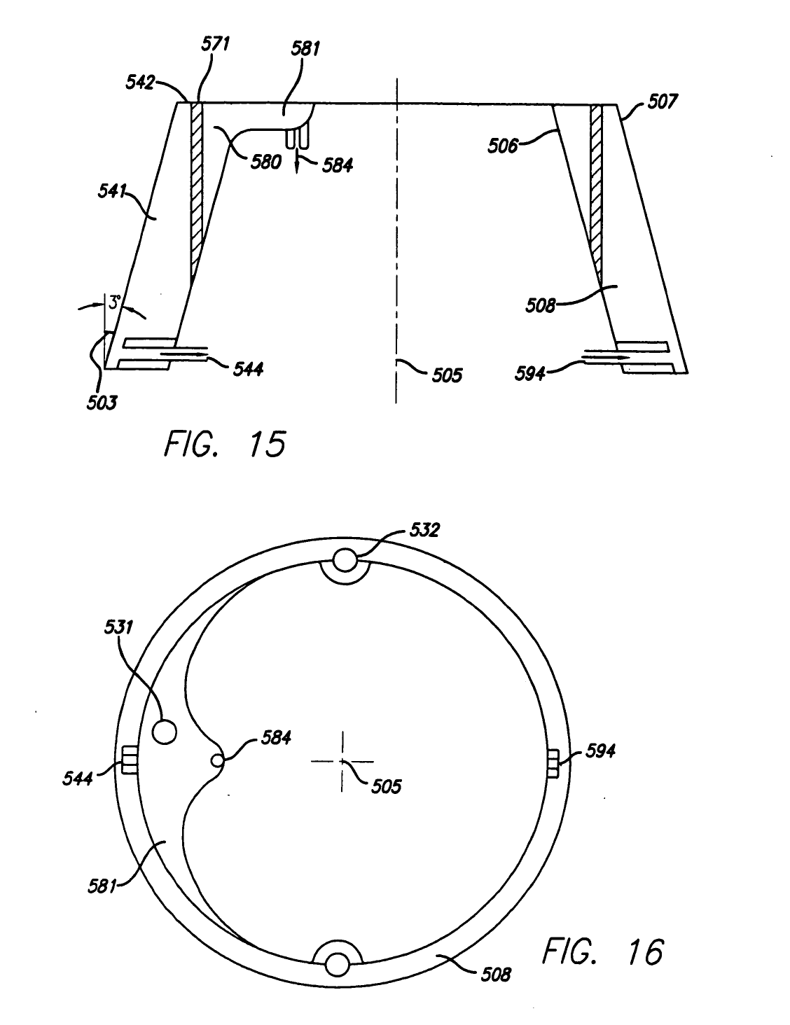

FIGS. 15 and 16 depict the separation channel of the CFC disk in accordance with an embodiment of the invention. FIG. 15 is a longitudinal cross-sectional view through the axis 505 of the separation channel 508. The inner surface 506 and outer surface 507 of the separation channel 508 are each independently configured at an angle from the spin axis 505; the angles may be the same or different from one another. In one embodiment, both the inner surface 506 and the outer surface 507 are at an angle of about three degrees from the spin axis 505. The separation channel 508 may thus increase in radius along its axis from top to bottom. In certain embodiments, the separation channel 508 extends conically with the separation between the inner surface 506 and the outer surface 507 being substantially smaller than the distance between the top and bottom of the channel. In further embodiments, either or both of the inner surface 506 angle from the spin axis 505 and the outer surface 507 angle from the spin axis 505 may vary from the lowermost portion, where the whole blood enters, to the highermost portion, where the plasma is removed. Thus, the channel 508 might be formed with one or both of the surfaces 506 and 507 curving. In further embodiments, the outer surface 507 may bulge out in the vicinity of the red cell outlet port 544 in order to increase red blood cell depth and hematocrit where the red blood cells are removed. The bulge may be local or extend all around or partially around the periphery of the channel. FIG. 16 depicts a top view of the of the CFC separation channel, in which the separation channel 508 inner and outer surfaces are a continuous circular conical section. The separation channel 508 has an annular shape with respect to any plane perpendicular to the axis and is positioned at or near the outer circumference of the CFC disk. A red cell outlet port 544 removes red cells at the top, or largest radius, of the separation channel 508. This shape imparts a large depth for the RBC layer during system operation, and provides strong g-force and packing of RBCs at the RBC outlet port 544. It provides a large packed RBC hematocrit for RBCs removed through the RBC outlet port 544 and minimizes the pulling of plasma to the RBC outlet port 544. The whole blood inlet port 594 may be positioned at a smaller radius than the RBC outlet port 544.

A plasma outlet port 584 is positioned within a plasma shelf 581 in the CFC disk. The plasma outlet port 584 and red cell outlet port 544 may each be positioned about 180° opposite a whole blood inlet port 594; however, the whole blood inlet port 594 position may independently vary with respect to the red cell outlet port 544 and plasma outlet port 584. The plasma outlet port 584 is positioned at a radius of the separation channel 508 smaller than the radius of the red cell outlet port 544. Moreover, the configuration of the plasma shelf 581 with respect to the plasma outlet port 584 may vary in alternate embodiments. In one embodiment, as depicted in FIG. 16, the plasma shelf 581 may extend roughly ninety degrees on both sides of the plasma outlet port 584, and may terminate in a lip. The lip is configured at a radius of the separation channel 508 smaller than the radius of the red cell outlet port 544.

The plasma shelf is configured somewhat like a funnel to collect plasma from a large area in the separation channel and direct it towards the plasma collection port with a flow-cross-section-area that decreases as flow moves toward the plasma collection port. The purpose of this “funnel” shape is to keep localized velocities for plasma low in and near the separation channel to allow any cells (red cells, white cells, or platelets) in the plasma to be separated by centrifugal forces. The plasma velocity component in the radially inward direction is intended to be less than the radially outward velocity of each cell under centrifugal forces. This causes cells to move to the RBC-plasma interface and not to be carried with plasma into the plasma product bag.

Plasma optical sensing pathway 531 and RBC interface optical sensing pathway 532 may be located within the separation channel 508.

During operation of the system to separate whole blood into its constituent parts, whole blood enters the separation channel 508 through the whole blood inlet port 594, and then separates; about half flows through the separation channel 508 in a clockwise direction and the remaining part flows in a counterclockwise direction. RBCs 541, plasma 580, and buffy coat layer 571 lie within the separation channel 508. The plasma shelf 581 aids in bringing plasma to the plasma outlet port 584. The plasma shelf 581 provides a large cross-sectional area for plasma 580 flow to the plasma outlet port 584, permitting cells to sediment out of this plasma 580 toward the red cell interface 542 (FIG. 15) and reducing plasma cellular contamination. The plasma shelf height can be from 1 mm to 10 mm. Plasma shelf height is preferably kept to about 2 to 6 mm in order to minimize plasma volume in the disk and overall disk blood volume, considerations in minimizing system extracorporeal volume.

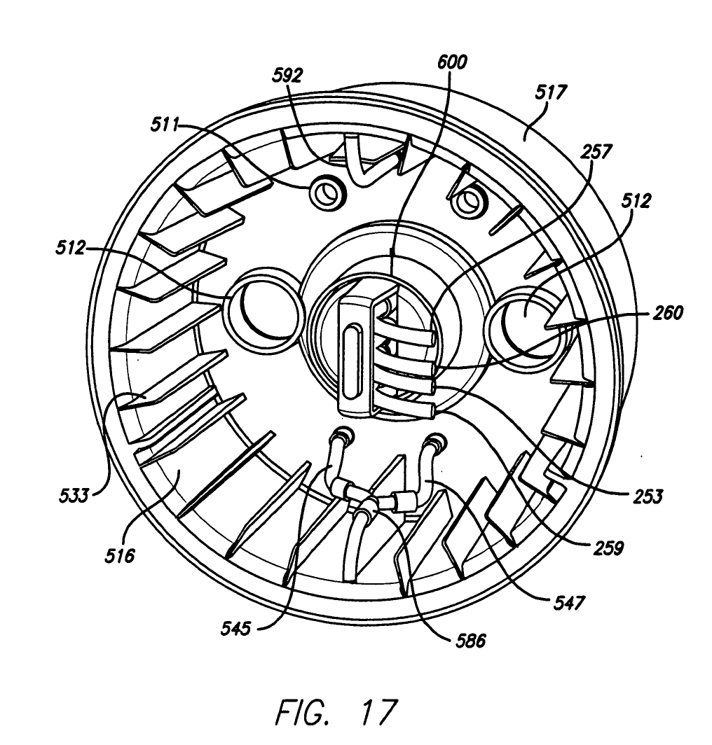

Storage solution or saline solution may be added to packed RBCs 541 after they pass through the RBC outlet port 544 and before the red cells enter the face seal of the CFC disk. The solution is metered into the flowing packed RBCs 541 at an approximately constant ratio. This ratio may be controlled by a microprocessor and software via the solution pump and the red cell pump. The addition of storage solution decreases the packed red cell hematocrit from about 90% to about 60% and significantly reduces viscosity. This permits RBCs to be removed from the CFC disk with lower pressure drops and lower red cell damage. As depicted in FIG. 17, a connector 586 joins the red cell outlet tube 545 and the solution tube 547, and enables the introduction of solution to the RBCs.

A seal assembly 600 and corresponding tubing provide fluid communication between the CFC disk and the manifold. The seal assembly 600 is positioned at the axial center of the CFC disk. The tubing includes the plasma from CFC disk to manifold line 257, the RBC from CFC disk to manifold line 260, the whole blood from manifold to CFC disk line 253, and the solution from manifold to CFC disk line 259. A red blood cell storage or additive solution, saline or another solution may be added to packed RBCs separated in the CFC disk, with the solution passing through a circumferential channel in the seal assembly 600. The radial location of the mixing location of solution and RBCs may be selected to maintain a low pressure in the solution channel in the range of about −200 mmHg to about +200 mmHg, preferably about +50 mmHg, in order to prevent forces that might separate the face seal elements or otherwise create a fluid leak into or out of the solution channel in the face seal. The mixing of solution and RBCs will reduce hematocrit and viscosity of the RBCs when they flow through the face seal, thereby reducing pressure drop and red cell damage caused by the face seal.

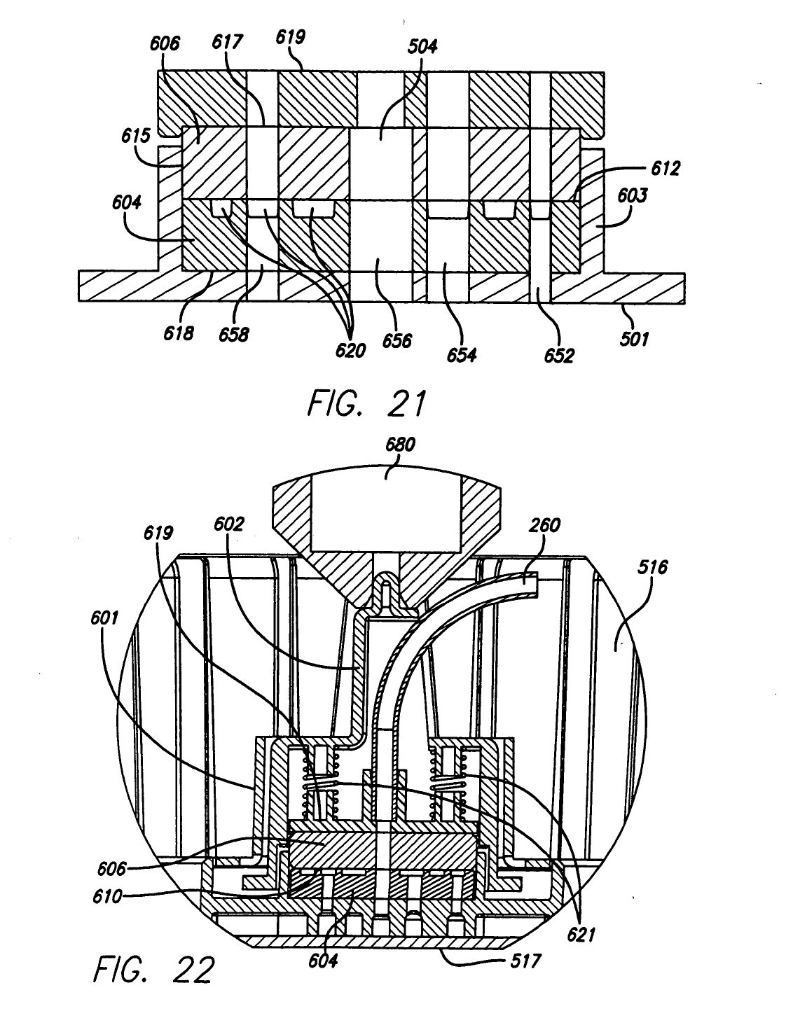

As depicted in FIG. 21, the seal assembly 600 includes a stationary seal 606 and a rotating seal 604; both of which may be composed of ceramic, although other materials may be used, as will be readily appreciated by one of skill in the art. Upon rotational movement of the CFC disk, the rotating seal 604 does not move relative to the CFC separation channel 508 (i.e., it rotates with the separation channel 508), while the stationary seal 606 is free to move relative to the separation channel 508. The seal assembly may include a plastic annular guide 603 with corresponding bearing surface 615 to center the stationary seal 606 over the rotating seal 604.

A series of channels are formed by the stationary seal 606 and rotating seal 604: a center channel 656 to transport red blood cells (after solution addition) from the CFC disk to the manifold, a first circumferential channel 654 to transport whole blood from the manifold to the CFC disk, a second circumferential channel 658 to transport plasma from the CFC disk to the manifold, and a third circumferential channel 652 to transport storage solution or saline solution from the manifold to the CFC disk. Center, first, second and third couplings in communication with the corresponding channels in the seal assembly 600 connect the respective channels with appropriate tubing to provide fluid communication between the channels and the manifold. These couplings are located in the distributor 619.

The radial location of the connector 586 where solution is added to RBCs is critical because it determines the pressure of the solution in its circumferential groove 652 in the face seal. This is the outermost groove in the face seal, separated from ambient air by the outer narrow face seal land. This land provides a fluid-tight seal before, during, and after disposable set use. It prevents non-sterile ambient air from entering the seal and contaminating the solution with bacteria, and it prevents the solution from leaking out of the seal. It is desired to maintain a slightly positive pressure of solution in its circumferential groove 652 in the seal. This positive pressure discourages ambient air from leaking into the seal as may be possible with a negative pressure. A low positive pressure of about +10 to +60 mmHg gauge also prevents pressure forces that could separate the seal faces and cause leaks or contamination, as may be possible with a higher pressure. The radial location of the connector where the solution is added to RBCs is directly related to the pressure because of the centrifugal field effects on pressure; the larger the radius, the higher the pressure. This optimal radial location providing the desired pressure is in the range of 0.3 inch to 1.0 inch from (radially less than) the radial location of the opening of the RBC duct in the separation channel.

The solution also provides the function of cooling the face seal elements and may also provide some lubrication or wetting to reduce rotating friction between these contacting seal elements.

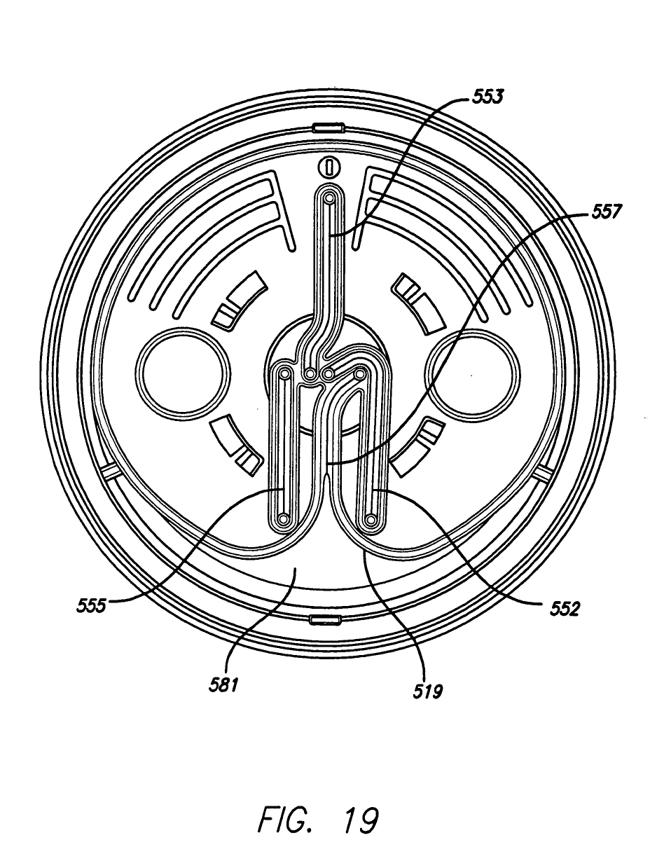

As depicted in FIG. 19, a series of passages are molded into the CFC disk as an alternative to using attached tubes as flow conduits. A first passage 553 transports whole blood from the first circumferential channel 654 to an inlet tube 592 that connects the first circumferential channel 654 with the whole blood inlet port 594. A second passage 552 transports RBCs from a red blood cell outlet tube 545 connected to the red cell outlet port 544 to the center channel 656. A third passage 555 transports storage solution or saline solution from the third circumferential channel 652 to the connector 586. A fourth passage 557 transports plasma from the plasma shelf 581 (via the plasma outlet port 584) to the second circumferential channel 658. The RBCs are directed through a center channel, because it is the channel with the least friction and lowest shear forces. Thus the RBCs, which are the most viscous and most subject to damage (e.g., via cell rupture), are not damaged as much as they could be if they went through a less central channel. The whole blood goes through the next closest channel, because it is the component next most likely to be damaged during centrifugation.

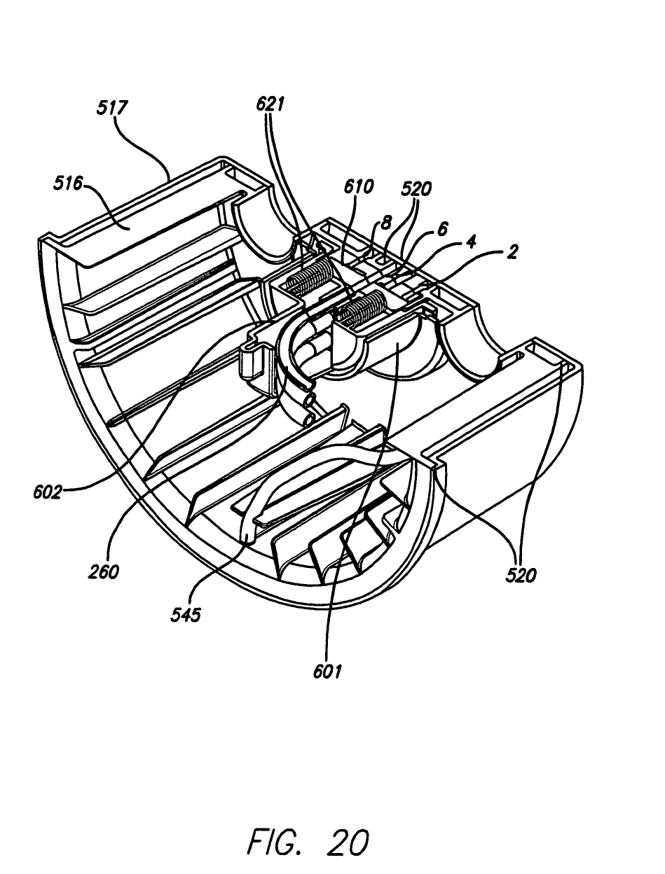

FIG. 22 is a horizontal cross-sectional view of the CFC disk seal assembly depicted in FIG. 20. As seen in FIG. 22, the seal assembly uses face seal springs 621 to maintain the seal faces together. This may be important when the CFC disk with seal is out of its sterile package, being installed in the console, and then during operation in the console to prevent contaminating ambient air leaks into the seal or fluid leaks out of the seal, as well as leaks between channels 652, 654 and 658. The face seal springs 621 ensure that the seal assembly does not leak even when abnormally high pressures occur at the solution region 652 or whole blood region 654. A cap is used to support the face seal springs 621 in compression at one end of the spring; the other end provides an axial compressive force on the distributor 619 and face seal 610. The cap has an outer lip that engages the disk housing to counter the spring force and limit cap travel axially. A positive pressure for the solution region 652 is selected so as to coact with the strength of the spring such that leaks or contamination is prevented while friction is kept low enough so as not to interfere with relative rotation of the seal faces. If too strong a spring is used, the friction will be high, leading to rotation problems. The spring force is made high enough to keep the seal faces in contact and to provide a good rotation seal while the pressure in the solution region 652 is kept high enough above 0 mmHg, but not excessively high (below 100 mmHg), to ensure that leaks and contamination are precluded.

When assembled into the drive cup on the front panel of the console, the CFC disk will first engage and slip easily into its drive mechanism. Locking ports 512 may be used for angular orientation of the CFC disk in the drive cup. The console door closure is used to engage the CFC disk such that certain components thereof can rotate freely and are positioned and supported correctly and safely within the centrifuge drive mechanism. The CFC disk seal assembly depicted in FIG. 22 shows a console door engagement piece 680 on the stationary seal housing 602.

The tongue 683 protruding from stationary seal housing 602 enters and engages with slot 684 in console door engagement piece 680. This engagement occurs when the door is closed and prevents the stationary seal housing 602 from rotating.

The stationary seal housing 602 is free to move in a direction along the spin axis (centered along the central RBC port in the seal). Its axial travel is limited in one direction by lip 681 on seal housing 602 contacting seal or mounting ring seat 682 on outer rotating housing 601. Travel is limited in the opposite direction by lip 681 on contacting surface 689. When the lip 681 is between seat 682 and contacting surface 689 it does not contact any rotating parts and the disk 517 with its separation channel is free to rotate with seal housing 602 and lip 681 held stationary.

As seen in FIG. 22, the door engages (680) the stationary seal housing 602, compressing the stationary seal housing 602 against the face seal springs 621, and moving the stationary seal housing 602 a fixed distance when the door is closed. This separates the engagement lip 681 from the mounting ring seat 682, permitting disk rotation.

Seal element 606 is bonded or attached to distributor 619. Distributor 619 is held stationary by engagement with stationary seal housing 602. One or more ribs 685 run axially inside seal housing 602 and engage slots 686 in distributor 619. The rib-in-slot engagement permits seal housing 602 to move axially while springs 621 prevent axial movement of distributor 619 and keep stationary seal element 606 forcibly pressed against rotating seal element 604.

When the centrifuge disk is not inside the console with the door closed, the springs 621 force lip 681 of seal housing 602 against seat 682 of outer rotating housing 601. One or more radial ribs or projections 687 on lip 681 engage open slots 688 on outer rotating housing 601. This engagement not only prevents relative rotation between these parts but also orients tongue 683 on outer rotating housing 601 so that it will automatically and properly engage slot 684 in engagement piece 680 when the door is closed, with no manual adjustment required. The console clocks the drive cup to a fixed angular orientation to achieve this alignment and permit tongue in slot engagement. When the door is closed, the axial movement of lip 681 is more than sufficient to disengage rib 687 from slot 688.

Console

The console may include: a console body with an enclosure, including a vertical front panel; a door hinged horizontally along its bottom edge and facing the console body front panel; roller tracks for the pumps are located in the door; four roller pumps with electric drive motors and drive mechanisms mounted in the console; valve actuators, pressure transducers, and ultrasonic sensors mounted on the front panel (these interact with sensing and actuation components in the disposable cassette and/or manifold inserted between the front panel and door); a centrifuge drive system that drives the disposable centrifuge disk with a drive cup that supports the outer wall of the disk; microprocessor-based control electronics and electronics that interface with all electromechanical components and the user interface components; software that implements, controls, monitors, and documents the processes carried out by the system of the invention; a user interface that provides user control of the process to a limited and well-defined extent, provides monitoring and warning functions for the user, and provides a bar-code wand reader for rapid and efficient data collection; a data port that permits process and system data to be transmitted to a printer, a portable memory, or the blood bank computer; and A.C. power as well as battery power operating capabilities.

The electronics located in the console may utilize a microprocessor based controller with a separate microprocessor for safety to meet medical device electronic system requirements. The electronic PC boards provide electronic interfaces to various motors, actuators, and sensors.

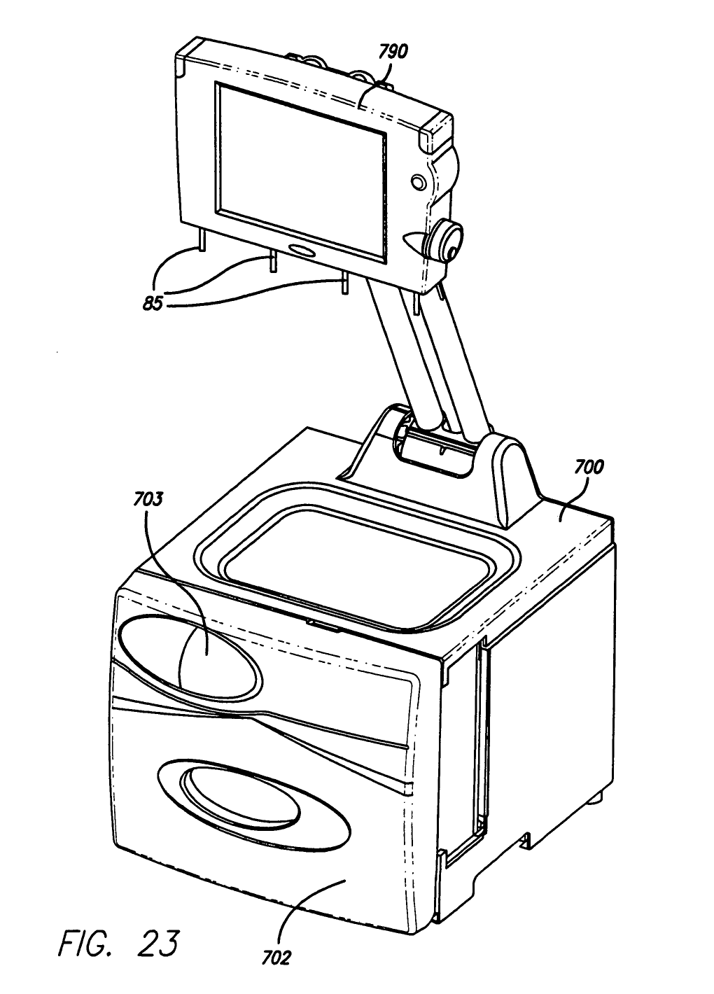

FIGS. 23-26 depict the overall design of the console in accordance with an embodiment of the invention. FIG. 23 depicts the console 700 with user interface display 790 deployed. The console door 702 permits user access to the console. A door handle 703 may be located on the console door 702. The user interface display 790 mounted at the top of the console 700 may include sealed push-button (diaphragm switch) controls for specific functions of the process. It may also contain an LCD color monitor for displaying the state of the process, for display and selection or process parameters, and for warnings or alarm conditions. The user interface display 790 may support bag hangers 85. Bag hangers 85 may be used to hang various fluid bags (e.g., saline or storage solution, RBC, plasma, anticoagulant and air bags). The bag hangers 85 are located below the user interface display 790. The bag hangers 85 are generally situated so that the bottom of the bags are spaced above the console 700.

In one embodiment of the instant invention (not shown), the bag hangers may be configured with individual scales that provide a measurement of the weight of each bag hanging therefrom. In this manner, the system can compute the fluid volume of any individual bag, based on its weight. This feature may be used, for example, to provide an indication of the bag fluid volume during operation of the system, to aid in function of an “off” feature when the bag reaches a desirable volume, or the like.

FIG. 26 depicts the console with the console door 702 in the open position and user interface display 790 deployed. The user interface display 790 may be controlled by a control knob 792 which may be pushed or rotated by the user. The console body 715 encloses electronic, electromechanical, and mechanical components. These components include a roller pump module 800 which pumps fluids throughout the system. Roller pump rotor tracks 850 which include four independent tracks, and seal housing guide 1600 may be located on the console door 702. The seal housing guide 1600 functions as an orientation guide for the centrifuge disk and opens the seal housing 602. The centrifuge drive cup 1500 is located on the front panel of the console which supports the centrifuge disk.

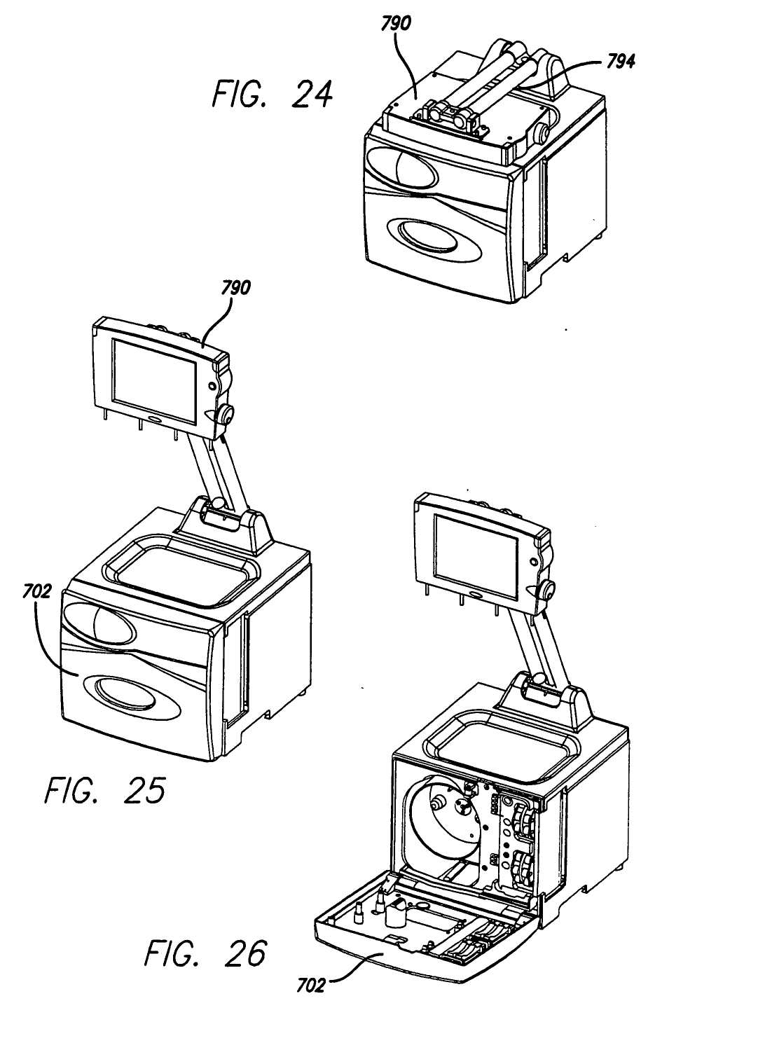

FIGS. 24-26 illustrate the console deployment process. FIG. 24 depicts the console in the closed position (i.e., user interface display 790 not deployed) for storage and transport. Telescoping tubes 794 function to support the user interface display 790. FIG. 25 depicts the console with the user interface 790 deployed and console door 702 closed. FIG. 26 depicts the console with the console door 702 open.

FIG. 27 illustrates the console front panel which is located on the vertical front side of the console body 715. Valve actuators 910, pressure transducers 930, and ultrasonic sensors 960 are mounted on the console front panel 705. The valve actuators 910 and pressure transducers 930 are mounted to a valve plate that is part of and attached to the console front panel 705. Valve actuators 910 are located opposite disposable valve components. The valve actuators 910 may have a solenoid-operated plunger that moves the diaphragm of the disposable valve component to open or occlude a fluid path orifice (FIG. 9), in those embodiments of the present invention that incorporate solenoid valves. This valve actuator may use a spring to close the valve and is electrically energized to open it. A low power level is needed to keep the valve open. The spring-loaded feature is a fail-safe advantage, ensuring that no fluid flow can occur with a system or power failure. The motion of the plunger may be independently monitored with a HALL effect or optical sensor to provide confirmation of proper valve function and a warning of solenoid failure. Pressure transducers 930 are flat-faced standard devices that couple directly to membranes on pressure measurement components in the manifold (FIGS. 10 and 11). The ultrasonic sensors 960 are air detection sensors used to couple to standard blood set tubing attached to the cassette frame.

The console front panel 705 includes a centrifuge drive cup 1500 that rotates the disposable CFC disk, and orientation pins 1502 that hang the disposable cassette onto the console front panel 705. The CFC drive cup may also include pins 1505 for orientation and locking of the CFC disk. The CFC drive cup 1500 is surrounded by a centrifuge bucket 1510 which is attached to the console front panel 705.

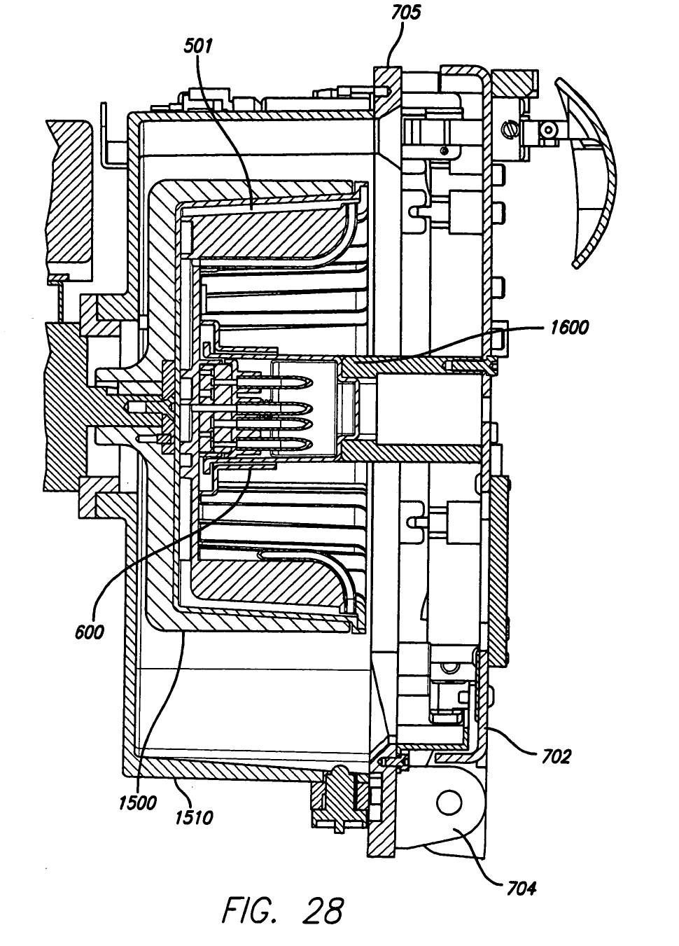

The pump rotors 810 mounted in the console body 715 are visible on the console front panel 705. A leak collection gutter 731, located near the bottom region of the console front panel 705, directs leaks to the leak reservoir 732. A hinge 704 may attach the console door to the console body along the horizontal bottom of the console front panel 705. FIG. 28 illustrates the hinge 704 and console door 702 in the closed position. The console door 702 may be secured and positioned to the console body by a latching mechanism located on the console front panel 705.

A bar code reader may be provided in order to take bar code data (e.g., identifiers, lot numbers, expiration dates) from bags, the user, the donor, and other sources. For example, the cassette may have a bar code read by the console bar code scanner window 720. This provides identification to the console of the process to be implemented. It may also provide cassette calibration (e.g., pump tubing, valves), cassette lot number, and expiration date. The console may provide date, time, and process and blood product information. Process and system data, process parameters, warnings, failures and a process validation may be provided to a central blood bank computer.

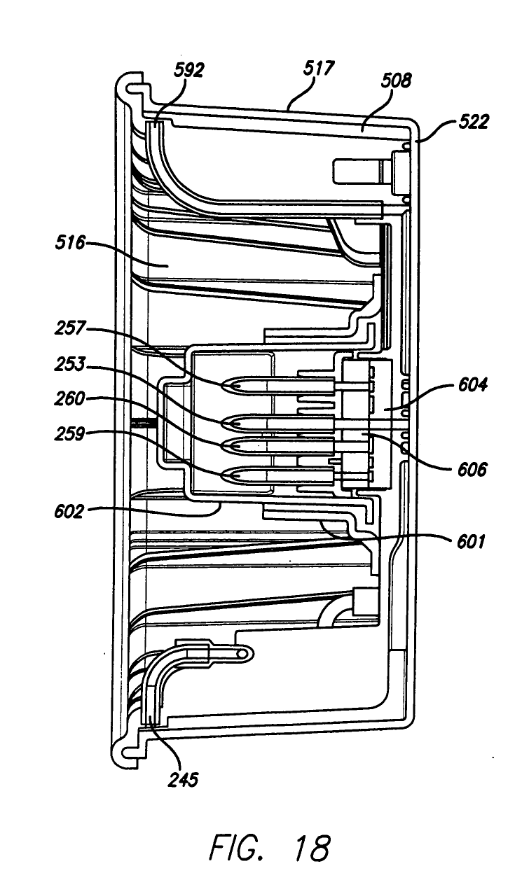

FIG. 28 depicts the centrifuge drive system. A centrifuge drive cup 1500 is located in the console front panel 705 and accepts and supports the disposable CFC disk 501. The centrifuge drive cup 1500 supports the CFC disk outer wall. The drive cup has a shield or centrifuge bucket 1510 around it inside the console front panel 705. The centrifuge drive cup 1500 is supported on a shaft which has bearings spaced at each end with a stationary structure supporting these bearings attached to the shield. The stationary centrifuge bucket 1510 is attached to the back of the console front panel 705. This achieves a leak-tight assembly preventing fluids from entering the console. The shaft may be driven by a brushless D.C. motor with position encoder. The motor drive electronics uses this encoder to achieve the necessary very smooth vibration-free constant-speed rotation of the rotor. The centrifuge drive cup 1500 supports and angularly orients the CFC disk 501. Seal housing guide 1600 can open the seal housing 602 (FIGS. 18, 20 and 22) of the centrifuge seal assembly 600.

Components of the roller pump mechanism are depicted in FIGS. 27 and 29. The roller pump module 800 may be located in the console body 715 and the roller pump rotor tracks 850 which include four independent tracks may be located on the console door 702. FIG. 27 illustrates the pump rotors 810, which may be visible on the console front panel 702. In other embodiments, the roller pump module may be located on the console door 702, and the roller pump rotor tracks 850 may be located in the console body 715.

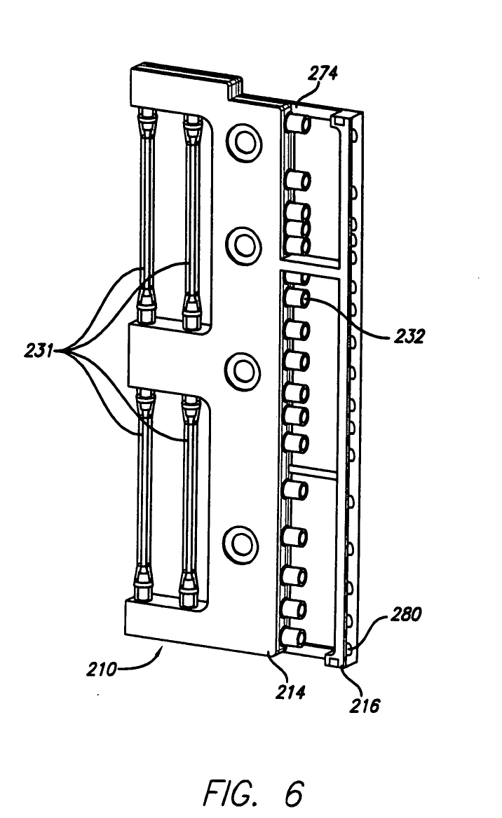

As illustrated in FIGS. 5 and 6, the pump tubing 231 includes four segments, parallel to each other, and are attached to the manifold in the same plane as the central plane of the manifold and parallel to both manifold surfaces. These parallel tubes are in two sets of two; in each set the tubes are adjacent each other, parallel, and closely spaced.

As depicted in FIG. 29, the pump rotors 810 engage pump tubing 231 in the manifold 210 when the console door 702 is closed and locked in place. The pump tubing 231 is disengaged when the console door 702 is open. When the console door 702 is closed, each pump rotor 810 compresses and occludes a segment of pump tubing 231 against a track. The pump rollers 818 on each rotor compress and occlude the pump tubing 231 against a curved block or roller pump track 851 that is mounted to the console door 702. The roller pump track 851 is spring-loaded against the pump rollers 818 to ensure adequate occlusion of the pump tubing 231 but avoid excessive force. The roller pump track 851 is pivoted on an arm parallel to the console front panel 705 at some distance from the center of the roller pump track 851. The roller pump track 851 is provided with a stop that limits its motion in the direction of the spring force (toward the pump rotors 810). The control of spring force and tubing compression by pump rotors 810 to the lowest level necessary to ensure occlusion and minimizes hemolysis in this pump design.

Each of the pump rotors 810 has eight pump rollers 818 equally spaced on its periphery. The small spacing between pump rollers 818 and the relatively large rotor diameter achieve a short roller pump track 851 length and short pump tubing 840 segment. This pump tubing 840 segment is deformed into a short, shallow arc by the pump rotors 810 and roller pump track 851. Short pump tubing 840 segments are advantageous in order to minimize overall manifold 210 size and cost and allow straight pump tubing 840 to be engaged easily and deformed into a short, shallow arc. This permits easy loading of the manifold 210 onto the console front panel 705, with pump tubing 840 located between the pump rotors 810 and pump track 851.

When the console door 702 is closed, the pump rotors 810 compress and occlude a segment of pump tubing 231 against the roller pump track 851. The pump rotors 810, supported by concentric drive shafts 830, are driven by belt drives and pulley components 820 which are powered by a total of four D.C. motors 806. The solenoid valve actuator and pressure sensor components 900 which are mounted in the console front panel 705 are located between the pump rotors 810 and the concentric drive shafts 830.

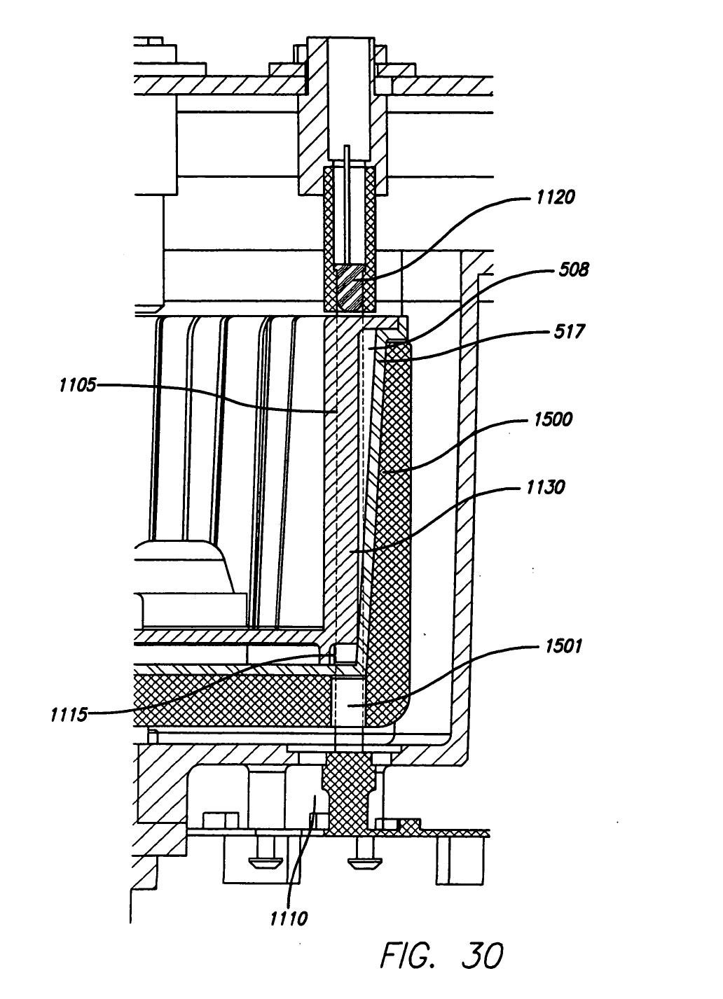

FIG. 30 is a longitudinal cross-sectional view of the CFC disk and RBC Interface optical detector pathway, and illustrates the centrifuge design used to detect and measure the location of the plasma-red cell interface within the separation channel 508 of the rotating centrifuge disk. An infra-red light source 1120 in the console door illuminates a segment of the separation channel 508 across part of the radial width of separation channel 508, from about 40% full of RBCs to 100% full. The red cell layer and buffy coat block the light pathway 1105 but the plasma transmits this light to a detector. The light passes through a hole 1501 in the disk drive cup 1500 (located radially outward from the outer disk wall 517) to an optical detector 1110. The optical detector 1110 receives an amount of light proportional to the radial width of the plasma in the separation channel 508 as determined by the location of the red cell-plasma interface which is within the separation channel's interface sensing region 1115. Then the analog detector output voltage increases when this interface moves radially outward and decreases when it moves radially inward. This detection of the interface location is used during continuous-flow operation in a feedback loop. The primary control may be determined by the RBC pump flow rate (removing RBCs from the rotor) and Blood Pump flow rate (feeding whole blood into the rotor). For example, as the ratio of RBC flow to Blood Pump flow increases, the red cell interface moves radially outward. One or more desired reference interface locations is established. The actual locations of the interface are measured by the optical detector as depicted in FIG. 30. The error signal of actual minus reference location (the optical analog values) changes the flow ratios described above proportional to the error signal with appropriate time constants or averaging. Then this system and method maintains the red cell-plasma interface in its desired locations. These locations may be programmed to move this interface reference radially inward to progressively or step-wise increasingly fill the separation channel 508 with RBCs. An objective is to have the separation channel 508 completely filled with RBCs when the donation is completed.

The donation (whole blood from the donor) may be selected at 500 ml, the preferred value, or pre-selected by the blood center or user at some other value from about 400 to 500 ml. The purpose of completely filling the separation channel with packed RBCs at a hematocrit of about 90%, plus buffy coat, is to remove all plasma from this channel to the plasma product bag, and maximize the volume of this plasma product.

As seen in FIG. 30, the RBC interface within the separation channel 508 is illuminated by the infra-red light source 1120 through a plastic rib 1130 that is molded to and part of the CFC disk inner wall. The rib 1130 extends from one end of the CFC disk nearest the infra-red light source 1120 to within about 4 mm of the outer wall (a flat wall perpendicular to the axis) of the separation channel. The rib 1130 is oriented axially and acts as a sort of light pipe or light conduit.

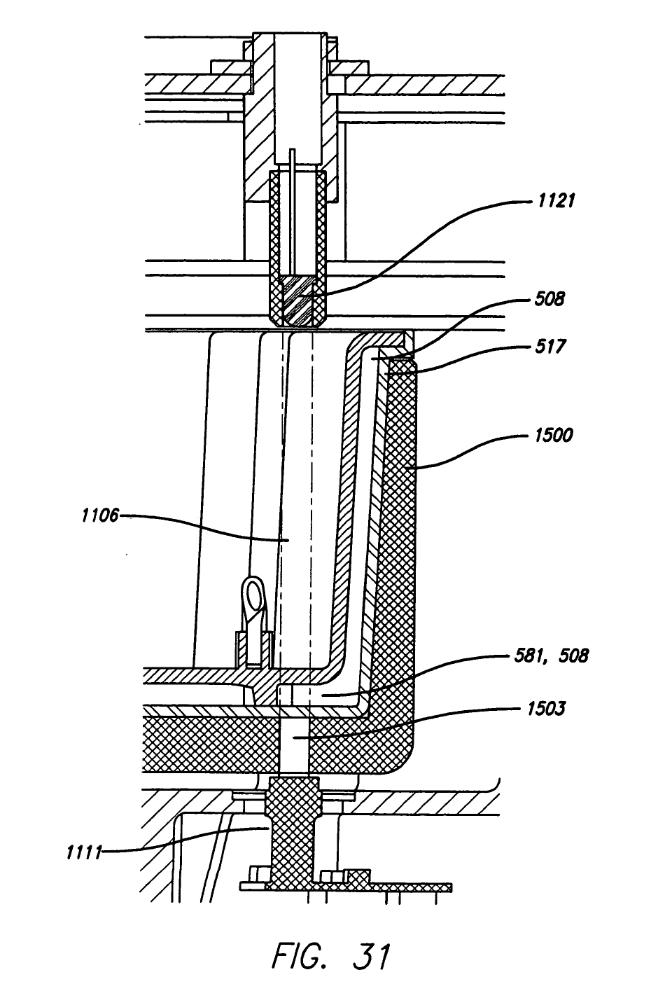

FIG. 31 is a longitudinal cross-sectional view of the CFC disk and plasma interface optical detector pathway. A separate infra-red light source 1121 and a separate sensor are used to detect the presence of cells, buffy coat, or possible red cells (any plasma contamination) in the plasma. The light pathway 1106 travels from the infra-red light source 1121 in the console door, through a portion of the separation channel 508, and through a hole 1503 in the disk drive cup 1500 (located radially outward from the outer disk wall 517) to an optical detector 1111. The detector output voltage decreases when some substantial contamination is present. This decrease in voltage may be used to terminate the donation, signaling when the separation channel 508 is full of RBCs and the buffy coat is being expressed into the plasma shelf region 581 near the plasma outlet port 584 (FIG. 16). Alternatively, this decrease in voltage may be used to control the RBC interface by decreasing RBC pump and/or Blood Pump flow rates.

The plasma path length for optical detection is made quite thin (about 4 mm) in both the separation channel 508 and the plasma shelf 581 optical sensing regions. This is intended to minimize the effect of plasma transmissibility, which is highly variable from donor to donor, on the accuracy of RBC interface location detection. It is desired to have a quite accurate and consistent, repeatable analog output signal from these detectors that can measure with precision the location of this RBC-plasma interface. Additionally, the plasma light source looks through a thin (about 2 mm) wall of plastic at the plasma shelf 581, illuminating a plasma layer about 4 mm thick axially.

### EXAMPLES

The following examples illustrate certain processes that may be implemented with the system of the present invention.

### Example 1

### A Blood Collection and Separation Process

Before blood donation begins, a disposable set is removed from its sterile package and hung on the console. Solution bags (anticoagulant, red blood cell additive solution, and saline) are attached to the console. Solution bags could be pre-attached but are assumed in these processes to be attached at disposable set-up. The solution bags may have Luer-lock or spike attachments. Bacterial (0.2 micron) filters are used in the flow paths from these bags to maintain sterility. The bags are hung in designated locations on the console. The console calibrations and system software status are performed automatically before blood donation begins. Data collection is performed manually by the user with a bar code wand reader and automatically via the console.

The processes of the present invention are automatic. The automatic process begins after the phlebotomist (user) places the access needle in the donor's vein and after the non-anticoagulated blood samples are taken into a pouch or diverter bag providing a sample site near the needle. Then the system start button is pressed or the system is activated by another way to begin the automatic process.

Each process begins with a filling or priming of the CFC disposable disk by whole blood with anticoagulant added. This CFC disk has an annular separation channel that has a volume of about 90 mL. This volume is initially filled with sterile air. This air is displaced by the whole blood entering the separation channel. The air is removed to a bag for use later in purging or removing blood components from the CFC disk and disposable set.

As blood flows from the donor in tubing that connects the donor to the disposable set, anticoagulant is metered into the whole blood. The ratio of anticoagulant flow to donor blood flow is fixed at about 1 to 7, the ratio currently used in manual blood collections. However, this ratio may be optimized at somewhere between 1 to 7 and 1 to 14 for processes that return blood components to the donor.

When the CFC disk separation channel becomes filled with donor blood, steady state operation begins. Blood flows from the donor into the CFC at a more or less fixed flow rate; separation of whole blood into packed red cells, plasma, and a buffy coat occurs continuously, and red cells and plasma are removed at more or less fixed flow rates from the CFC.

An interface between the red cell layer and the plasma forms near the center of the CFC separation channel. An optical detector measures the radial location of this interface. This interface position is controlled to be maintained at or near the center of the separation channel throughout most of steady-state continuous-flow operation, and then the interface is moved radially inward to displace (remove) all plasma to the plasma product bag. This is achieved primarily by changing the RBC pump flow rate to remove greater or fewer RBCs from the separation channel, using standard feedback control methods.

When the donor hematocrit is above 40%, the RBC flow rate will increase appreciably at a fixed donor blood flow rate. In order to maintain a maximum effective and safe flow rate through the leukofilter, the RBC flow rate has a maximum value. When it reaches this maximum flow rate, then the donor flow is increased or decreased to maintain the red cell-plasma interface in its desired location. This will increase the donation time for that small percentage of donors who have hematocrits substantially above 40% and who are donating a fixed pre-set volume of whole blood. This will not increase donation time for donors who are donating a fixed volume of RBCs.

The buffy coat consists of white cells (including leukocytes) and platelets. It is less dense than red cells and more dense than plasma. Consequently the buffy coat forms a radially narrow white region at or near the radial center of the separation channel, at the red cell-plasma interface. The packed red cells are at the outermost part of the annular channel and against the outer wall of the channel. The plasma is at the innermost part of the channel and against the inner wall. The buffy coat collects throughout the steady state continuous-flow separation process at this red cell-plasma interface.

During the purge or component removal part of the process the buffy coat is either removed to another bag, left in the CFC disk, or left in tubing and other components in the disposable set. It is not pumped into or through the leukofilter with the packed red cells. In certain embodiments of the invention, the buffy coat in the air bag or another bag at the end of the separation and donation step is removed. This removal of buffy coat from the whole blood decreases the amount of leukocytes that must be removed by the leukofilter. The desired leukocyte count in the packed red cells after leukofiltration is about ×106. Platelet reduction by buffy coat removal is also beneficial. Platelets can form a layer on the leukocyte filter or otherwise plug it, increasing leukofilter pressure drop with resultant hemolysis, and forcing lower flow rates to avoid hemolysis. Buffy coat removal therefore significantly aids leukoreduction and permits higher flow rates with a smaller, lower-cost filter having less filter volume and consequently less red cell loss in the filter.

The packed red cells are pumped out of the CFC disk, through a leukofilter, and into a RBC product bag. A storage or additive solution is metered into the packed RBC flow stream at a rate that achieves the desired concentration or hematocrit of RBCs. This occurs before the RBC pump, within the CFC disk.

The RBC pump flow rate is controlled so that the flow through the leukofilter is maintained at or near an optimum. This optimum is a flow high enough that it does not increase donation time or process time appreciably, and low enough to prevent high leukofilter inlet pressures and resultant hemolysis.

At the end of the donation, when the selected volume of whole blood or RBCs, and/or plasma has been taken from the donor, the needle is removed from the donor. As the end of the donation approaches, the CFC disk separation channel may be almost completely full of packed red cells. When the donation ends, the blood in the donor line may be pumped out by anticoagulant flow. Then the buffy coat may be pumped into the air bag by reverse flow of the RBC pump. The packed red cells filling the separation channel are then pumped through the leukofilter into the RBC product bag, with the addition of storage solution to the RBCs as before.

Storage solution is pumped into the leukofilter to purge or remove RBCs trapped in the leukofilter and pump them into the RBC product bag, to minimize red cells lost in the disposable set and maximize overall red cell recovery. The volume of storage solution used for this purpose is limited by the maximum amount of storage solution that can be added to a unit of red cells, and by the possible liberation of leukocytes from the leukofilter which are then carried into the RBC product bag.

The red cell product has been separated from one or more units of whole blood, has been packed to a hematocrit of about 90%, has had storage solution added, and has been leukofiltered. It has been placed in one or two product bags at the end of the process. Plasma is expelled to the plasma bag by the differential flow rates of the whole blood pump and the packed RBC pump, as in steady state operation. The end of the process occurs when the leukofilter purge is completed. The product bags are now sealed off and removed from the set. The disposable set is then removed from the console and the set is prepared for disposal as a biohazard material.

### Example 2

### One Unit of Leukoreduced RBCs and Plasma

In one embodiment of the invention, one unit of whole blood is collected from a donor to produce one unit of leukoreduced RBCs in storage solution and plasma. This embodiment of the invention is depicted in FIG. 2. The system depicted in FIG. 2 includes a donor needle 110, sample pouch 22, sample site 21, manual clamps 31, 32 and 33, ultrasonic air sensors US1, US2 and US3, solenoid valves V1 and V2, pressure sensors P1, P2, P3 and P4, anticoagulant bag 138 and storage solution bag 122 attached by connectors 71 and 72, bacterial filters 141 and 142, anticoagulant pump 162, solution pump 163, blood pump 161, RBC pump 164, air bag 128, plasma bag 132, CFC 500, leukofilter 150, RBC bag 131, and air pouch 25 connected to line segment 41.

As seen in the schematic depicted in FIG. 2, this process automatically takes whole blood from the donor; adds anticoagulant from an anticoagulant bag 138; separates the blood into concentrated red cells and plasma in the CFC 500; removes plasma to the plasma bag 132; adds storage solution to the concentrated red cells; and pumps the red cells through a leukofilter 150 into an RBC bag 131.

The anticoagulant bag 138 and storage solution bag 72 are attached by connectors 71 and 72 such as Luer-lock or spike attachments to the blood processing system. Bacterial filters 141 and 142 are used in the anticoagulant bag 138 flow path and storage solution bag 72 flow path to ensure the maintenance of sterility. During this process, the anticoagulant is pumped by way of an anticoagulant pump 162 to the donor line to purge air and ensure correct anticoagulation of the first amount of blood pumped from the donor. The donor venous needle access is made by the phlebotomist in standard fashion. Removal of the manual clamp 32 near the donor needle 110 purges anticoagulant from the line near the sample pouch 22. Then the manual clamp 31 on the sample pouch 22 is opened and blood fills the sample pouch 22. The sample pouch 22 is then clamped by manual clamp 31. Blood samples can subsequently be taken from sample pouch 22.

Blood is pumped from the donor at rates determined by donor venous pressure. Anticoagulant is pumped into the blood downstream of the donor needle 110 and upstream of a blood sample site 21. The ratio of anticoagulant flow to blood flow is fixed.

As blood is pumped initially from the donor it begins to fill (prime) the disk separation channel of the CFC 500. The CFC 500 disk is rotated at a moderate speed to ensure all air removal and that blood completely fills the disk channel and passages. Air is displaced into an air bag 128 for later use. When the disk separation channel of the CFC 500 is filled with whole blood, its speed is increased and steady-state continuous-flow separation into concentrated red cells and plasma begins. Red cells are pumped out at a rate determined by the whole blood flow rate and by the optically-measured red cell interface location. The red cell flow rate is adjusted to keep the red cell interface in the desired, optimal location in the separation channel of the CFC 500. Plasma flows out into the plasma bag 132.

When red cells flow out of the CFC 500 disk they are mixed with a storage or additive solution prior to entering the face seal to reduce viscosity and red cell damage. This storage solution is pumped by a solution pump 163 at a flow rate that achieves the fixed, desired ratio of additive solution flow to red cell flow. The combined flow goes through a red cell leukofilter 150 into the RBC bag 131.

This continuous-flow process continues until the end of the donation. The user has selected a whole blood or RBC volume to be collected from the donor and the calibrated whole blood pump 161 stops when this volume has been collected. The donor blood line is purged with anticoagulant to maximize red cell and plasma recovery. Red cells fill the entire separation channel at this point. All plasma has been removed to the plasma bag 132. Then red cells are pumped back into the disk by the RBC pump 164 to displace the buffy coat and anticoagulant into the air bag 128. The donor line at the needle is then clamped off and the needle is removed from the donor.

The CFC 500 disk speed is decreased and air flows into the rotor from air bag 128, as RBCs are pumped out of the rotor, through the leukofilter 150 (after storage solution addition) and into the RBC bag 131. Storage solution is pumped through the red cell lines and leukofilter 150 to purge red cells and maximize red cell recovery. Air is then removed from the RBC bag 131 and plasma bag 132. An air pouch 25 or small flexible bag at the end of the line segment 41 attached to the RBC bag 131 may be used to collect air from the RBC bag 131 and fill line segment 41 with RBCs from the RBC bag 131. The RBC bag 131 and plasma bag 132 are then heat-sealed off and the disposable set is removed and disposed of.

### Example 3

### Whole Blood Separation into Leukoreduced RBCs and Plasma Products

A more detailed description of the user implementation of the process depicted in FIG. 2 (one unit of leukoreduced RBCs in storage solution and plasma are produced), is described here. The user plugs in the system, switches the system on, and closes the console door. The system warms up to the operating temperature range and then initializes in which the system boots up. The system then performs a self check in which it internally checks to see if components, as for example, pumps, valves, and sensors, are responding properly. The user unpacks the disposable set and waits until the user interface display 790 (FIG. 23) indicates “ready to accept disposable.” The user then opens the console door, installs the disposable set into the console, closes the console door, clamps the donor needle 110 line, clamps the sample pouch 22 line, clamps the line segment 41, hangs the pre-attached bags (anticoagulant bag 138, storage solution bag 122, RBC bag 131, plasma bag 132, and air bag 128), and presses the continue button.

The system then performs a disposable and system self check. During this step, the system determines the type of disposable set installed based on its bar code, checks to see whether the disposable set is installed correctly, checks the lines clamped, checks the disposable set's integrity (e.g., leak check), checks internal system points, moves air if required, and zeros transducers. A protocol confirmation is achieved when the user interface display indicates “Protocol disposable may process is . . . ” The user confirms that the disposable set recognized agrees with protocol to be performed and presses the continue button for “yes.”

Then the disposable set is prepared for blood donation. The user interface display reads “Attach solutions to set per IFU.” The user hangs the anticoagulant bag 138 and storage solution bag 122 by spike or luer attachments and presses the continue button. The anticoagulant line to sample pouch 22 is primed. Confirmation with the anticoagulant pump 162 time/rotations and ultrasonic air sensor US2 and flow is established. Back pump reverses the system to reduce the amount of anticoagulant in the tubing. The user then prepares the donor.

The storage solution line to CFC 500 is primed concurrently with the anticoagulant priming. Confirmation with solution pump 163 and ultrasonic air sensor US3 and flow is established. Confirmation that the system is ready for the donor is then established and the user interface displays “ready for a donor.” The user then further prepares the donor and phlebotimizes, unclamps the donor needle 110 line and sample pouch 22 line and draws volume of blood into sample bag 22 along with air in line. Afterward, the user clamps/seals off the sample pouch 22, removes it from the disposable set, and takes VACUTAINER samples from the sample pouch 22. The user then presses the continue button to start the drawing of blood.

The blood donation begins, and the blood primes the system. Blood is drawn at a maximum of 65 ml/minute from the donor filling line to CFC 500 with anticoagulant being metered. The system then pauses to check zero at donor line pressure transducer No. 1. The CFC 500 is primed during which whole blood fills the CFC 500 while spinning and developing separation interface. At this point, all air is purged to air bag 128 and RBC and white blood ports are covered with blood. Priming of the CFC 500 continues as whole blood fills the CFC 500, rotations per minute (“RPM”) increases (from about 1000 RPMs to 4000 RPMs) until the plasma optical sensor sees liquid, a little RBCs are pulled to clear seal, and all air is purged to air bag 128. At the completion of the priming of the CFC 500, the CFC is rotating at its operable speed which is about 4000 to 4500 RPMs, the plasma port is clear, and the valve to plasma bag 132 is switched.

The leukofilter 150 is primed at a maximum of about 25 ml/min for 35 ml volume. During this stage, the leukofilter 150 is primed with blood, storage solution is metered to RBC flow, plasma is drawn, and a RBC bed is built in CFC 500 during the leukofilter 150 priming. During separation, blood is drawn at rates acceptable to donor pressure and leukofilter 150 flow of about 45 ml/min maximum; this is the steady state part of the run. A RBC bed is built in anticipation of the end of draw volume, purging out plasma. The CFC 500 rate increases to about 5000 RPM to pack the RBC bed and minimize plasma contamination. The RBC bed is built until the buffy coat is in the plasma port. Switch valves V1 and V2 continue to build the RBC bed, pushing the buffy coat and some RBC into the plasma line and air bag 128.

The donation ends when the donor draw volume is reached. Blood pump 161 and anticoagulant pump 162 ratio is adjusted to purge donor line of RBCs to CFC 500 and the line to air bag 128 is open at this step of the process.

The CFC 500 rotation comes to a stop and homes to RBC port at the six o'clock position. The user attends to the donor, and the donor is removed from the system when the user interface display indicates “clamp needle line and remove donor.” Subsequently, the user clamps the donor needle 110 line, removes the donor needle 110, applies a needle protector, and applies a sterile gauze onto the donor.

RBCs are purged from the CFC 500. The drawing of the RBC from the CFC 500 allows air to return from the air bag 128 (ratio storage solution) by a timed drain or optical detector in disk. At this stage, the user attends to the donor. The leukofilter 150 is purged by pumping 30 ml of storage solution into the leukofilter 150 to purge out remaining RBCs. Airing out the plasma occurs when the user interface displays “Invert Plasma Product Bag and Purge Air.” At this point, the user inverts the plasma bag 132, presses and holds the remove air button, squeezes plasma bag 132 until air is removed, seals tube to bag and presses continue.

Airing out RBCs occurs when the user interface displays “Invert RBC Product Bag, mix and purge air.” The user then inverts the RBC bag 131 and mixes it, presses and holds the remove air button until air reaches the mark in the tube line segment 41, seals tube at mark, and presses continue.

The process is complete when the user interface displays “process complete, Please remove set.” The user then opens the console door, removes the disposable set, removes the anticoagulant bag 138, storage solution bag 122, RBC bag 131, plasma bag 132, and air bag 128, and disposes the disposable set as appropriate. At this point, the system detects no barcode and is ready to accept a new disposable set as indicated by the user interface display which reads “Ready to Accept Disposable.”

### Example 4

### Two Units of Leukoreduced RBCs

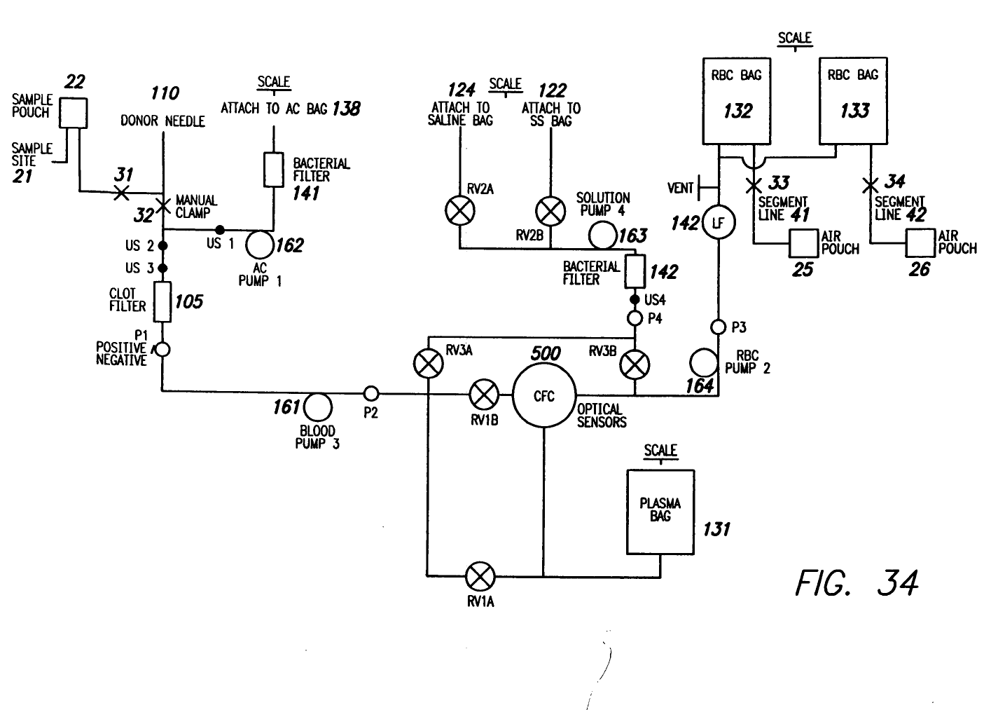

In another embodiment of the invention, sufficient whole blood is collected from a donor to produce two units of leukoreduced RBCs in storage solution. This embodiment is depicted in FIG. 34. This system includes a donor needle 110, sample pouch 22, sample site 21, manual clamps 31, 32, 33 and 34, ultrasonic air sensors US1, US2, US3 and US4, rotary valves RV1A, RV1B, RV2A, RV2B, RV3A and RV3B, pressure sensors P1, P2, P3 and P4, anticoagulant bag 138, storage solution bag 122, saline bag 124, bacterial filters 141 and 142, clot filter 105, anticoagulant pump 162, solution pump 163, blood pump 161, RBC pump 164, plasma bag 131, CFC 500, leukofilter 150, RBC bags 132 and 133, and air pouches 25 and 26 connected to line segments 41 and 42.

The 2RBC Process produces two products (bags) of leukoreduced AS-5 RBCs of 180, 200, and 210 ml maximum target absolute RBC volume for each unit. All plasma is returned to the donor.

The AC, SS, and saline lines are primed. A total of three to four draws and return cycles are used for each donor to accumulate the target RBC volumes and return all plasma.

In the first donor draw the disk fills with anticoagulated donor blood, displacing air in the disk and donor line to the plasma holding bag. The disk, rotating at low speeds initially and then about 4250 RPM, separates the blood into packed red cells and plasma. As whole blood enters the disk, the RBC-plasma interface is developed and moves radially inward. The RBC pump is initially off until the interface reaches about 50 ml of packed RBCs in the disk. Then the RBC pump speed is controlled to maintain this interface at somewhere between 50 ml to 95 ml of packed RBCs. The maximum disk volume is about 95 ml. The RBC pump pumps RBCs, after storage solution addition, through the leukofilter into the RBC product bag. When the donor blood volume specified for this first draw cycle is reached, then the donor draw and RBC pump flow stop. Plasma flows to the plasma holding bag throughout this first draw.

The first return of plasma to the donor then begins, with all plasma in the plasma bag pumped out of this bag by the whole blood pump to the donor. One of the rotary valves (RV1) opens a tubing connection between the plasma bag and a Tee located between the disk and the whole blood pump. This valve also closes the tubing connection between the Tee and the disk to prevent pumping RBCs out of the disk. During this return flow, some RBCs may be slowly pumped out of the disk through the leukofilter to the RBC product bag. Saline is added to plasma in the return to achieve a near-zero intravascular volume change at the end of this and each draw and return cycle.

The second donor draw step controls the RBC interface to between 50 ml to 95 ml of packed RBC volume at the end of this second draw. RBCs are pumped through the leukofilter to the RBC product bag during this step. Plasma flows to the plasma holding bag. This step ends when a specified volume of donor blood has been collected during this draw. The second return step is similar to the first. A third draw and return cycle, if not the final cycle, is similar to the second cycle.

The final (third or fourth) draw step ends when RBCs pumped to the RBC product bags reach their target volume as measured by RBC product bag scales. Then the final return to the donor pumps all of the contents of the disk and plasma bag to the donor via the whole blood inlet port. The plasma bag contents may be returned first to the donor. This return may include the accumulated buffy coat or, the buffy coat may remain in the disk, or the buffy coat may be pumped to the leukofilter. Air from the plasma bag backfills the disk. Saline is added to the returning plasma and any returning RBCs. The disk and donor line are emptied of plasma and RBCs.

The donor is now disconnected from the M2000 system. The process ends by purging the leukofilter with storage solution to remove as many RBCs as possible. Alternatively, the disk may be almost fully emptied after the donor is disconnected. The remaining RBCs and buffy coat stay in the disk or are pumped to the leukofilter. Then the leukofilter is purged.

### Example 5

### One Unit of Leukoreduced RBCs and a Large Unit of Plasma (RBCP Process)

The RBCP Process produces one unit of leukoreduced RBCs in additive solution of 180 to 210 ml maximum target absolute RBC volume. This process also produces about 450 ml to 550 ml maximum target plasma volume. No plasma is returned to the donor; only RBCs are returned to the donor.

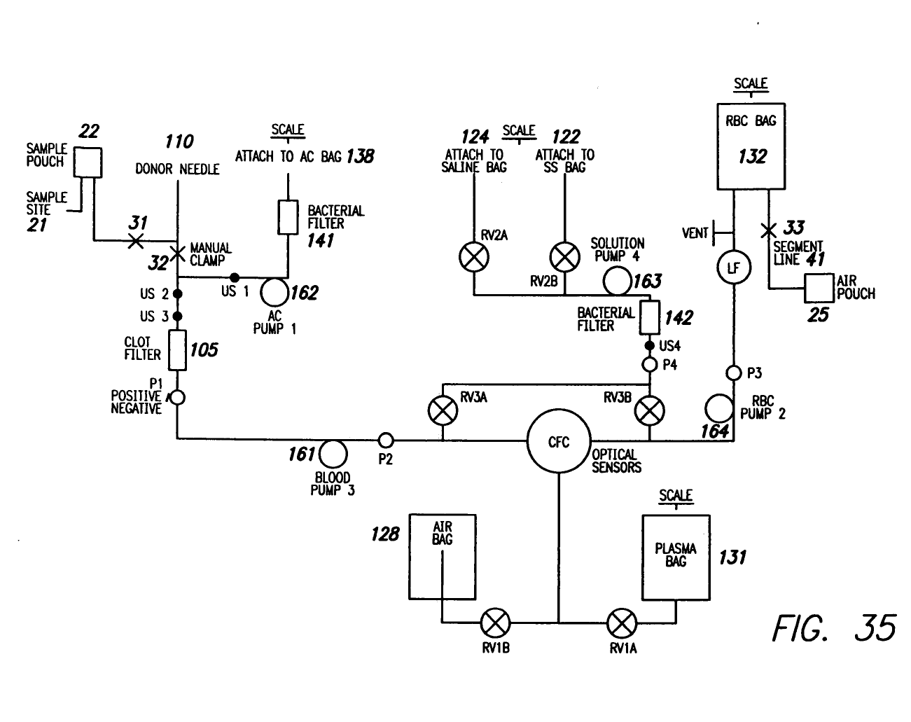

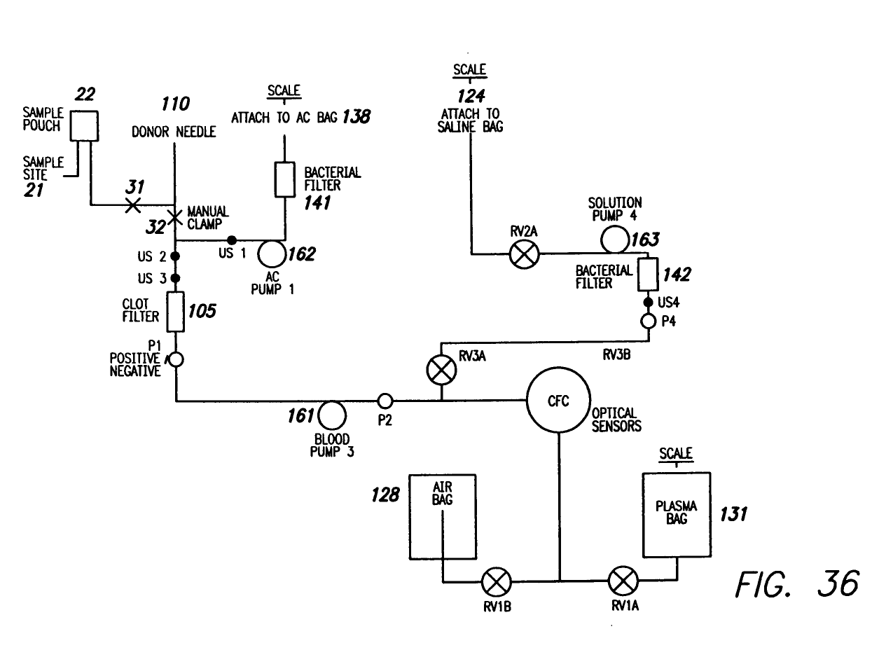

The schematic for this process is depicted in FIG. 35. This system includes a donor needle 110, sample pouch 22, sample site 21, manual clamp 31, 32, and 33, ultrasonic air sensors US1, US2, US3, and US4, rotary valves RV1, RV2, and RV3, pressure sensors P1, P2, P3, and P4, anticoagulant bag 138, storage solution bag 122, saline bag 124, bacteria filters 141 and 142, clot filter 105, anticoagulant pump 162, solution pump 163, blood pump 161, RBC pump 164, air bag 128, plasma bag 131, RBC bag 132, and air pouch 25 connected to segment line 41.

The AC, SS, and saline lines are primed. A total of perhaps three to eight cycles of donor draw and return steps are needed to obtain these blood products. The number of cycles depends upon donor hematocrit, weight, and extracorporeal and intravascular volume considerations.

In the first donor draw the disk fills with anticoagulated donor blood, displacing air in the disk and donor line to the air bag. The disk develops a packed RBC-plasma interface that gradually moves to fill the disk almost completely with packed RBCs (perhaps 70 to 90 ml of RBCs). Plasma flows to the plasma product bag. Some RBCs are pumped to the RBC product bag after adding SS and passing through a leukofilter.

In the first return step all RBCs in the disk are returned to the donor via the whole blood pump and the disk whole blood inlet port. Saline is metered into these red cells by the solutions pump. Plasma flows back into the disk as packed RBCs are removed. The disk continues to spin during all return steps to maintain plasma-red cell separation and achieve a largely cell-free plasma.

These draw and return steps are repeated until both absolute RBC target volume and plasma target volume are achieved, as determined by scales separately weighting the two product bags.

The disk is emptied after the last donor draw step and after the plasma target volume has been reached by pumping all packed RBCs in the disk into the RBC product bag. Air from the air bag backfills the disk. Then the leukofilter is purged with storage solution to improve RBC recovery.

The donor is removed from this system immediately after the final donor draw step.

### Example 6

### The Plasma Only Process

The Plasma Only Process produces about 450 ml to 800 ml maximum target plasma volume. No plasma is returned to the donor; only RBCs are returned to the donor.

The schematic for this process is depicted in FIG. 36. This system includes a donor needle 110, sample pouch 22, sample site 21, manual clamp 31 and 32, ultrasonic air sensors US1, US2, US3, and US4, rotary valves RV1, RV2, and RV3, pressure sensors P1, P2, and P4, anticoagulant bag 138, saline bag 124, bacteria filters 141 and 142, clot filter 105, anticoagulant pump 162, solution pump 163, blood pump 161, air bag 128, and plasma bag 131.

The AC, SS, and saline lines are primed. A total of perhaps three to eight cycles of donor draw and return steps are needed to obtain these blood products. The number of cycles depends upon donor hematocrit, weight, and extracorporeal and intravascular volume considerations.

In the first donor draw the disk fills with anticoagulated donor blood, displacing air in the disk and donor line to the air bag. The disk develops a packed RBC-plasma interface that gradually moves to fill the disk almost completely with packed RBCs (perhaps 70 to 90 ml of RBCs). Plasma flows to the plasma product bag. Some RBCs are pumped to the RBC product bag after adding SS and passing through a leukofilter.

In the first return step all RBCs in the disk are returned to the donor via the whole blood pump and the disk whole blood inlet port. Saline is metered into these red cells by the solutions pump. Plasma flows back into the disk as packed RBCs are removed. The disk continues to spin during all return steps to maintain plasma-red cell separation and achieve a largely cell-free plasma.

These draw and return steps are repeated until both absolute RBC target volume and plasma target volume are achieved, as determined by scales separately weighting the two product bags.

The disk is emptied after the last donor draw step and after the plasma target volume has been reached by pumping all packed RBCs in the disk into the RBC product bag. Air from the air bag backfills the disk. Then the leukofilter is purged with storage solution to improve RBC recovery.

The donor is removed from this system immediately after the final donor draw step.

### Example 7

### One Unit of Leukoreduced RBCs, Plasma and Buffy Coat

Another embodiment of the invention employs an identical blood collection and processing process as depicted in FIG. 2 to produce one unit of leukoreduced RBCs in storage solution and plasma except that the buffy coat collected is removed to a product bag. Whole blood is collected from a donor to produce one unit of leukoreduced RBCs in storage solution, plasma and buffy coat.

The buffy coat, a mixture of leukocytes and platelets, develops at the red cell-plasma interface in the CFC 500 (FIG. 2). It is collected within the disk separation channel of the CFC 500 throughout the donation and separation process. As seen in FIG. 2, the buffy coat may be pumped into the air bag 128 at the end of plasma removal. In this embodiment, the buffy coat along with some plasma is pumped out of the CFC 500 and into a platelet product bag, which could be the air bag 128 with a removal port for the buffy coat.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A disposable set for a blood separations system comprising:
a needle adapted to draw blood from a donor;
a continuous-flow centrifuge disk including:
an inner disk wall;
an outer disk wall; and
a separation channel therebetween including:
an inner surface,
an outer surface,
an inlet port to introduce whole blood into the separation channel,
a first outlet port to remove concentrated red blood cells from the separation channel,
a second outlet port to remove plasma from the separation channel, and wherein the inner surface and the outer surface of the separation channel are each independently configured at a non-zero angle relative to a spin axis;
a manifold including:
a housing with a back cover and a front cover;
fluid pathways inside the housing;
one or more elastomer diaphragms at least partially inside the housing in fluid communication with one or more of the fluid pathways;
one or more valves in fluid communication with one or more of the fluid pathways, adapted to be deformed, wherein the deforming of the one or more valves closes one or more fluid pathways; and
one or more sets of tubing segments in fluid communication with one or more of the fluid pathways, wherein the tubing segments are adapted to be depressed to move fluid through one or more of the tubing segments;
one or more product bags adapted to hold blood components separated in the continuous-flow centrifuge; and
tubing connecting the continuous-flow centrifuge to the needle, to the manifold, and to the one or more product bags.

2. The disposable set of claim 1, further including a safety guard for covering the needle.

3. The disposable set of claim 1, wherein the continuous-flow centrifuge disk further comprises a plasma shelf to facilitate movement of the plasma into the second outlet port.

4. The disposable set of claim 1, wherein the first outlet port is positioned at a first radial distance from a center of the continuous-flow centrifuge disk, the inlet port is positioned at a second radial distance from the center of the continuous-flow centrifuge disk, and the first radial distance is greater than the second radial distance.

5. The disposable set of claim 1, wherein the second outlet port is positioned at a third radial distance from the center of the continuous-flow centrifuge disk, and the first radial distance is greater than the third radial distance.

6. The disposable set of claim 3, wherein the continuous-flow centrifuge disk further comprises a plasma shelf to facilitate movement of the plasma into the second outlet port, wherein the plasma shelf further includes a lip configured at a fourth radial distance from the center of the continuous-flow centrifuge disk, the fourth radial distance being less than the first radial distance.

7. The disposable set of claim 1, wherein the separation channel is located at or near an outer circumference of the continuous-flow centrifuge disk.

8. The disposable set of claim 1, wherein the non-zero angle is about three degrees with respect to both the inner surface and the outer surface of the separation channel, relative to the spin axis.

9. The disposable set of claim 1, wherein the inlet port is positioned about 180° opposite the first outlet port.

10. The disposable set of claim 1, wherein the continuous-flow centrifuge disk further comprises a seal assembly located at or near a center region of the continuous-flow centrifuge disk, the seal assembly comprising a stationary seal and a rotating seal, wherein, upon rotational movement of the continuous-flow centrifuge disk, the rotating seal does not move substantially relative to the separation channel and the stationary seal is free to move substantially relative to the separation channel.

11. The disposable set of claim 10, wherein the seal assembly further comprises:
a center channel to transport red blood cells,
a first circumferential channel to transport whole blood,
a second circumferential channel to transport plasma, and
a third circumferential channel to transport storage solution, wherein the center, first circumferential, second circumferential, and third circumferential channels are adapted to be in fluid communication with components of a blood processing apparatus by virtue of center, first, second, and third couplings that correspond to the channels and that are configured upon the stationary seal.

12. The disposable set of claim 11, wherein the continuous-flow centrifuge disk further comprises:
a first passage to transport whole blood from the first circumferential channel, and an inlet tube to transport whole blood from the first passage to the inlet port;
a first outlet tube to transport red blood cells from the first outlet port, and a second passage to transport red blood cells from the first outlet tube to the center channel;
a third passage to transport storage solution from the third circumferential channel, a storage solution tube to transport storage solution from the third passage to the first outlet tube, and a connector to connect the storage solution tube to the first outlet tube; and
a fourth passage to transport plasma from the plasma shelf to the second circumferential channel.

13. The disposable set of claim 1, wherein the continuous-flow centrifuge disk further comprises at least one orientation hole adapted to interact with an orientation pin to rotationally orient the continuous-flow centrifuge disk in a centrifugal disk drive cup.

14. The disposable set of claim 1, wherein the continuous-flow centrifuge disk comprises two orientation holes configured about 180° opposite one another.

15. The disposable set of claim 1, wherein the continuous-flow centrifuge disk further comprises a red blood cell interface optical detector pathway configured axially through the continuous-flow centrifuge disk, and a plasma interface optical detector pathway configured axially through the continuous-flow centrifuge disk.

16. The disposable set of claim 10, wherein the rotating seal and the stationary seal are each constructed of ceramic.

17. The disposable set of claim 10, wherein the continuous-flow centrifuge disk further comprises a stationary seal housing to maintain mechanical contact between the stationary seal and the rotating seal.

18. The disposable set of claim 17, wherein the stationary seal housing permits rotational movement of the stationary seal with respect to the rotating seal only when sufficient axial force is applied to the stationary seal housing to move the stationary seal housing an axial distance toward the continuous-flow centrifuge disk.

19. The disposable set of claim 1, wherein the manifold further includes a clip to secure the one or more sets of tubing segments in place.

20. The disposable set of claim 1, wherein the manifold further includes pressure sensors to measure fluid pressure in the fluid pathways and wherein the one or more elastomer diaphragms are adapted to interact with pressure sensors.

21. The disposable set of claim 1, wherein at least one of the one or more sets of tubing segments is parallel to another set of tubing segment.

22. The disposable set of claim 1, further comprising a storage solution bag to hold storage solution, the storage solution bag being fluidly connected to the continuous-flow centrifuge disk by one or more lengths of tubing.

23. The disposable set of claim 22, further comprising a bacterial filter on at least one of the one or more lengths of tubing connecting the storage solution bag to the continuous-flow centrifuge disk.

24. The disposable set of claim 1, further comprising an anticoagulant bag to hold anticoagulant, the anticoagulant bag being fluidly connected to the continuous-flow centrifuge disk by one or more lengths of tubing.

25. The disposable set of claim 24, further comprising a bacterial filter on at least one of the one or more lengths of tubing connecting the anticoagulant bag to the continuous-flow centrifuge disk.

26. The disposable set of claim 1, further comprising an air bag fluidly connected to the continuous-flow centrifuge disk by one or more lengths of tubing.

27. The disposable set of claim 1, further comprising a leukofilter fluidly connected to the continuous-flow centrifuge disk by a first set of one or more lengths of tubing and wherein one of the one or more product bags is a red blood cell product bag fluidly connected to the leukofilter by a second set of one or more lengths of tubing.

28. A method for separating blood using the disposable set of claim 1, comprising:
collecting whole blood from a donor;
processing the whole blood through a continuous-flow centrifuge disk comprising:
an inner disk wall;
an outer disk wall; and
a separation channel therebetween, comprising:
an inner surface,
an outer surface,
an inlet port to introduce whole blood into the separation channel,
a first outlet port to remove concentrated red blood cells from the separation channel, and
a second outlet port to remove plasma from the separation channel, and wherein the inner surface and the outer surface of the separation channel are each independently configured at a non-zero angle relative to a spin axis;
collecting a volume of red blood cells from the continuous-flow centrifuge disk; and
collecting a volume of plasma from the continuous-flow centrifuge disk.

29. The method of claim 28, wherein the continuous-flow centrifuge disk further comprises a plasma shelf to facilitate movement of the plasma into the second outlet port.

30. The method of claim 28, further comprising adding storage solution to the red blood cells.

31. The method of claim 28, further comprising adding anticoagulant to the whole blood.

32. The method of claim 28, wherein the disk further includes a seal assembly located at or near an axial center region of the disk, the seal assembly comprising a stationary seal and a rotating seal, the method further comprising configuring the continuous-flow centrifuge disk in a disk drive cup to permit rotational movement of the stationary seal with respect to the rotating seal.
